(19) United States
(12) Patent Application Publication
(10) Pub. No.: US 2015/0009142 A1
(43) Pub. Date: Jan. 8, 2015

(54) INFORMATION PROCESSING DEVICE, METHOD FOR OPERATING INFORMATION PROCESSING DEVICE, AND INFORMATION PROCESSING SYSTEM

(71) Applicant: FUNAI ELECTRIC CO., LTD., Osaka (JP)

(72) Inventor: Hideki SUGIMOTO, Osaka (JP)

(21) Appl. No.: 14/319,454

(22) Filed: Jun. 30, 2014

(30) Foreign Application Priority Data
Jul. 3, 2013 (JP) 2013-140124

(51) Int. Cl. G06F 3/0346; G06F 3/038

(52) U.S. Cl. CPC G06F 3/0346; G06F 3/038
USPC 345/158

(57) ABSTRACT

An STB that receives (i) a selection button operation corresponding to a press of one of selection buttons of a remote control and (ii) a cursor operation corresponding to a tilt of a case of the remote control, the STB including: a display control unit that displays a pointer on a display screen according to the cursor operation and displays, if the pointer is on an object displayed on the display screen, a plurality of input items assigned to the object; and an input item receiving unit that receives one of the input items displayed by the display control unit, according to the selection button operation.

### CROSS-REFERENCE TO RELATED APPLICATION

The present application is based on and claims priority of Japanese Patent Application No. 2013-140124 filed on Jul. 3, 2013. The entire disclosure of the above-identified application, including the specification, drawings and claims is incorporated herein by reference in its entirety.

### FIELD

The present invention relates to information processing devices, and particularly to an information processing device that operates a pointer based on information from a remote control including an angular velocity sensor, a method for operating an information processing device, and an information processing system.

### BACKGROUND

Examples of a device that outputs video to a television (TV) include a device allowing character input using a gyro remote control (a pointing device) including an angular velocity sensor (refer to Patent Literature (PTL) 1, for instance). Specifically, such a device is a set-top box (STB), an AV apparatus, a game console, or the like.

If character input is performed, the device displays, on a TV screen, a character input scene including a pointer that indicates a position of the remote control, a software keyboard, and a character input field that shows an input character (refer to PTL 2, for instance). The device disclosed in PTL 1 receives angular velocity information indicating an angular velocity from the gyro remote control, and moves a pointer according to the angular velocity information.

FIG. 17 and FIG. 18 each are a diagram showing an exemplary character input scene SC100. The character input scene SC100 shows a character input field F1, a software keyboard SK100, and a pointer P.

The character input field F1 is a region showing a character specified through an operation on a remote control.

The software keyboard SK100 is displayed on the display screen, and includes keys K1 to K13. The keys K1 to K13 each correspond to characters. For example, the key K1 corresponds to the English alphabets “a,” “b,” and “c,” the numeral “1,” and the “ [symbol] ” column of the kana syllabary. Likewise, the other keys K2 to K13 correspond to shown characters.

If information indicating that an enter button has been pressed is received from the gyro remote control when the pointer P is on one of the keys, display of the key and the pointer P is switched in the character input scene SC100.

FIG. 17 shows an exemplary character input scene in the case where the enter button of the gyro remote control has not been pressed. At this time, an isosceles triangle arrow image GP1 is shown as the pointer P. Moreover, each of images GK 101 of the keys K1 to K13 includes one region. The image GK101 of the key K2 shows “deft2 [symbol] ,” for instance.

FIG. 18 shows an exemplary character input scene in the case where the enter button of the gyro remote control has been pressed. At this time, a circular image GP2 is shown as the pointer P. Moreover, an image GK102 of the key K2 includes regions. One character is assigned to each of the regions. Specifically, the image GK102 of the key K2 when the pointer is on the key K2 includes nine regions to each of which a corresponding one of the characters “d,” “e,” “f,” “2,” “ [symbol] ,” “ [symbol] ,” “ [symbol] ,” “ [symbol] ,” and “ [symbol] ” is assigned. The image GK 101 and the image GK102 have the same size.

If the information indicating that the enter button has been pressed is not continuously transmitted from the gyro remote control (the enter button is released) with the character input scene shown in FIG. 18 displayed, an STB shows, in the character input field, a character assigned to a region corresponding to a position of the pointer P.

### CITATION LIST

### Patent Literature

[PTL 1] Japanese Unexamined Patent Application Publication No. 2013-069349
[PTL 2] Japanese Unexamined Patent Application Publication No. 2003-330599

### SUMMARY

### Technical Problem

In the character input using the gyro remote control, however, especially when a user operates a button of the gyro remote control, a position of a pointer is likely to be shifted due to hand movement. In particular, in the case where a region to which each character is assigned, such as the image GK102 of the key K2 shown in FIG. 18, is small, the pointer is likely to deviate from a region of a character to be input. The deviation of the pointer from the region of the character to be input results in inputting wrong information.

Moreover, in the case where the region to which each character is assigned, such as the image GK102 of the key K2 shown in FIG. 18, is small, it is difficult to bring, using the gyro remote control, the pointer to the region to which the character to be input is assigned.

In response, operating a key with only the button of the remote control without using the angular velocity sensor makes it possible to reduce the number of inputs of a wrong character caused by hand movement, but the number of operations increases.

The present invention has been conceived in view of the above problems, and an object of the present invention is to provide an information processing device that reduces the number of inputs of wrong information caused by hand movement, a method for operating an information processing device, and an information processing system.

### Solution to Problem

In order to achieve the above object, an information processing device according to one aspect of the present invention is an information processing device that receives (i) a selection button operation corresponding to a press of one of selection buttons of a remote control and (ii) a cursor operation corresponding to a tilt of a case of the remote control, the information processing device including: a display control unit configured to display a pointer on a display screen according to the cursor operation and display, if the pointer is on an object displayed on the display screen, a plurality of input items assigned to the object; and an input item receiving unit configured to receive one of the input items displayed by the display control unit, according to the selection button operation.

Such an information processing device performs the object selection through the cursor operation in combination with the input item specification through the selection button operation. For this reason, with the information processing device, the pointer may be on any input item on the object, and a user does not need to keep the pointer only on a region associated with an input item to be selected.

It is to be noted that the objects are images selectable with the pointer, such as icons, software keys, and buttons.

Specifically, for instance, if the user wants to input “ [symbol] ” in FIG. 18, the user has needed to bring the pointer P onto a relatively small region of “ [symbol] ” in the past. In contrast, with the information processing device, the pointer P may be at any one of positions of “d,” “e,” “f,” “2,” “ [symbol] ,” “ [symbol] ,” “ [symbol] ,” “ [symbol] ,” and “ [symbol] .” A pressed selection button among the selection buttons determines which one of the characters “d,” “e,” “f,” “2,” “ [symbol] ,” “ [symbol] ,” “ [symbol] ,” “ [symbol] ,” and “ [symbol] ” is to be input.

In other words, with the information processing device, a region onto which the pointer is brought is wide when a button of the remote control is pressed, that is, an allowable range for position shift of the pointer caused by hand movement is relatively wide, it is possible to reduce the number of inputs of wrong information caused by the hand movement.

It is to be noted that with the information processing device, since an operation of a position of the pointer is performed through the cursor operation (e.g. measurement of an angular velocity of the remote control), it is possible to prevent an increase in the number of button operations on the remote control for object specification (e.g. key selection) more effectively than in the case where character input is performed through only the button operation.

With the information processing device, the number of wrong inputs can be reduced as stated above, and thus it is possible to reduce power consumption of the information processing device.

For example, the display control unit may display, as the object, an image including a plurality of regions each corresponding to a different one of the input items. Moreover, the display control unit may display, as the object, the image including the regions, when the pointer is on the object, and display, as the object, an image added with patterns representing the input items, when the pointer is off the object.

With these configurations, the present invention can be applied to a software keyboard.

Each of the input items may be assigned to a different one of the selection buttons.

With the information processing device, since each input item is assigned to the different selection button, it is possible to specify an input item through the selection button operation.

Furthermore, the number and an arrangement of the input items of the object may be the same as the number and an arrangement of the selection buttons of the remote control.

With the information processing device, since the number and arrangement of the regions of the object is the same as the number and arrangement of the selection buttons of the remote control, the user can operate the remote control without looking at the remote control.

It is to be noted that the same arrangement above means the same arrangement relationship, and means that if the selection button Bs is arranged above the selection button Bs5 in FIG. 1, for instance, a region corresponding to the selection button Bs2 is arranged above a region corresponding to the selection button Bs5. An interval between two of the selection buttons does not need to be the same as an interval between corresponding two regions. In addition, a shape of the selection buttons does not need to be the same as that of the regions.

Moreover, the object may be larger when the pointer is on the object than when the pointer is not on the object.

With the information processing device, the object increases in size when the pointer is on the object, and thus it is possible to effectively reduce the number of the inputs of the wrong information caused by the hand movement when the selection button operation is performed.

Furthermore, the pointer may be smaller when the pointer is on the object than when the pointer is not on the object.

With the information processing device, the pointer decreases in size when the pointer is on the object, and thus the user can easily view display on the object.

Moreover, if the information processing device continuously receives a plurality of the selection button operations while the pointer is continuously on the object, the input item receiving unit may receive, among the input items, input items each corresponding to one of the received selection button operations.

With the information processing device, if the user wants to continuously input the input items associated with the same object, the user can perform a simple operation, a continuous operation of the selection buttons, for such input.

Specifically, in a character input scene shown in FIG. 18, if the user wants to continuously input the input items associated with the same object, for instance, the user repeatedly performs, after moving the pointer onto the object, the following three operations: (1) pressing an enter button (an image of a key changes), (2) moving the pointer into a region of a character to be input, and (3) releasing the enter button.

In contrast, with the information processing device, after moving the pointer onto an object, the user can continuously input characters only through repetition of one simple operation, that is, (1) pressing a selection button.

The information processing device may further include a storage unit that stores the object that is set for each of types of a plurality of the remote controls, wherein if the display control unit further receives, from the remote control, remote control information identifying a type of the remote control, the display control unit may display the object according to the remote control information.

Since the information processing device is capable of corresponding to the types of the remote controls, it is possible to increase the versatility of the information processing device. It is to be noted that the storage unit does not need to be included in the same device.

In order to achieve the above object, an information processing system according to one aspect of the present invention includes: a remote control that includes a plurality of selection buttons and outputs (i) a selection button operation corresponding to a press of one of the selection buttons and (ii) a cursor operation corresponding to a tilt of a case of the remote control; and an information processing device that receives, from the remote control, the selection button operation and the cursor operation, wherein the information processing device includes: a display control unit configured to display a pointer on a display screen according to the cursor operation and display, if the pointer is on an object displayed on the display screen, a plurality of input items assigned to the objet; and an input item receiving unit configured to receive one of the input items displayed by the display control unit, according to the selection button operation.

Since the information processing system includes the information processing device, it is possible to reduce the number of the inputs of the wrong information caused by the hand movement without increasing the number of the button operations.

It is to be noted that the present invention can be realized not only as the information processing device including such characteristic processing units but also as a method for operating an information processing device, which includes, as steps, processes executed by the characteristic processing units of the information processing device. Moreover, the present invention can be realized as a program causing a computer to function as the characteristic processing units of the information processing device or a program causing the computer to execute the characteristic steps of the method for operating an information processing device. It goes without saying that such a program can be distributed via a non-transitory computer-readable recording medium such as a CD-ROM (Compact Disc Read-Only Memory) or a communication network such as the Internet.

### Advantageous Effects

The present invention provides an information processing device that reduces the number of inputs of wrong information caused by hand movement, a method for operating an information processing device, and an information processing system.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a diagram showing an exemplary information processing system 1.

FIG. 2 is a block diagram showing an exemplary internal configuration of a remote control.

FIG. 3 is a block diagram showing an exemplary configuration of an STB according to Embodiment 1.

FIG. 4 is a flow chart showing an exemplary procedure of a method for operating an information processing device.

FIG. 5 is a diagram showing an exemplary character input scene (a case where a pointer is out of a key range) in Embodiment 1.

FIG. 6 is a diagram showing an exemplary character input scene (a case where a pointer is within a key range) in Embodiment 1.

FIG. 7 is a diagram showing an exemplary character input scene (a case where a pointer is out of a key range) in a modification of Embodiment 1.

FIG. 8 is a diagram showing an exemplary character input scene (a case where a pointer is within a key range) in the modification of Embodiment 1.

FIG. 9 is a diagram showing an exemplary transition of an image of a key in the case where a pointer P is within a key range in the modification of Embodiment 1.

FIG. 10A is an external view showing an exemplary appearance of a remote control according to Embodiment 2.

FIG. 10B is an external view showing another exemplary appearance of the remote control according to Embodiment 2.

FIG. 11 is a diagram showing an exemplary character input scene (a case where a pointer is out of a key range in a kana input mode) in Embodiment 2.

FIG. 12 is a diagram showing an exemplary character input scene (a case where a pointer is within a key range in the kana input mode) in Embodiment 2.

FIG. 13 is a diagram showing an exemplary character input scene (a case where a pointer is out of a key range in an English alphabet input mode) in Embodiment 2.

FIG. 14 is a diagram showing an exemplary character input scene (a case where a pointer is within a key range in the English alphabet input mode) in Embodiment 2.

FIG. 15 is an exemplary table used when a remote control is switched.

FIG. 16 is a flow chart showing an exemplary procedure followed when a remote control is switched.

FIG. 17 is a diagram showing an exemplary character input scene (a case where an enter button of a gyro remote control has not been pressed).

FIG. 18 is a diagram showing an exemplary character input scene (a case where the enter button of the gyro remote control has been pressed) corresponding to FIG. 17.

FIG. 19A is a diagram showing an exemplary character input scene (a case where a pointer is out of a key range) in Embodiment 4.

FIG. 19B is a diagram showing an exemplary character input scene (a case where a pointer is out of a key range) in Embodiment 4.

FIG. 20 is a diagram showing an exemplary character input scene (a case where a pointer is within a key range) in Embodiment 4.

FIG. 21 is a diagram showing an exemplary character input scene (a case where a pointer is out of a key range) in a modification of Embodiment 4.

FIG. 22 is a diagram showing an exemplary character input scene (a case where a pointer is within a key range) in the modification of Embodiment 4.

FIG. 23 is a diagram showing an exemplary transition of an image of a key in the case where a pointer is within a key range in the modification of Embodiment 4.

### DESCRIPTION OF EMBODIMENTS

The following describes in detail embodiments of the present invention with reference to the drawings. It is to be noted that each figure neither necessarily shows a dimension nor strictly shows a dimensional ratio.

Moreover, the exemplary embodiments described below each show a preferable, specific example. The numerical values, shapes, materials, structural elements, the arrangement and connection of the structural elements, steps, and the processing order of the steps, etc. in the following exemplary embodiments are mere examples, and are not intended to limit the scope of the present invention. The present invention is defined by the claims. Therefore, although among the structural elements in the following exemplary embodiments, structural elements not recited in any one of the independent claims are not always needed to achieve the object of the present invention, such structural elements are described as elements of a more preferred configuration.

### Embodiment 1

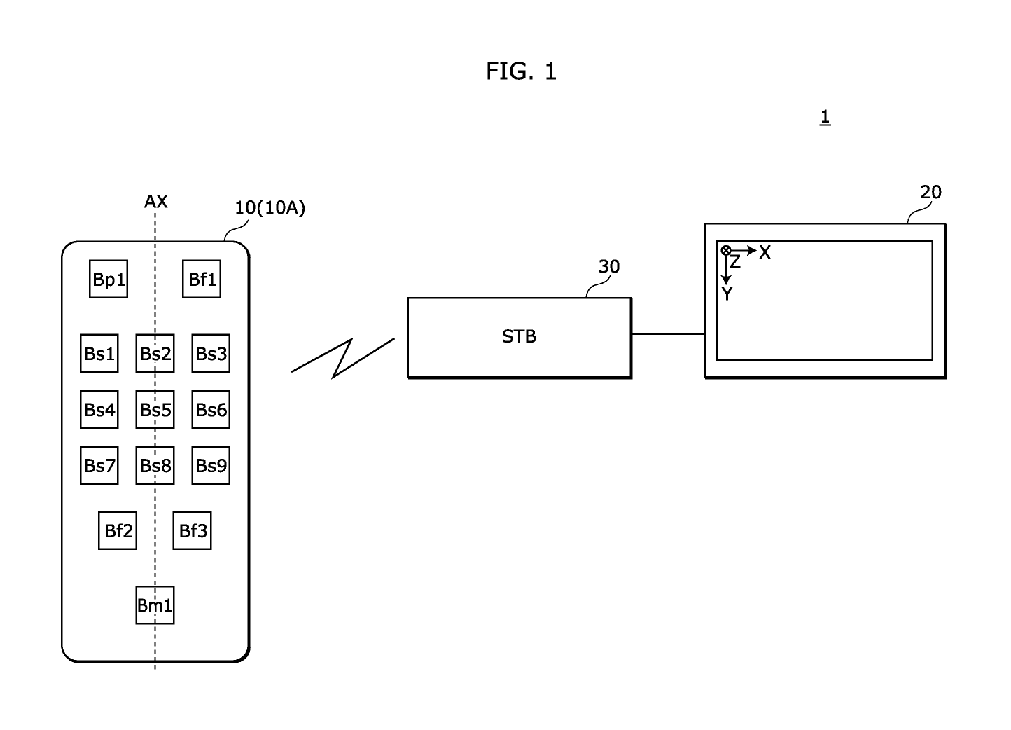

An information processing device, a method for operating an information processing device, and an information processing system according to Embodiment 1 are described below based on FIG. 1 to FIG. 6.

FIG. 1 is a diagram showing an exemplary information processing system 1. As shown in FIG. 1, the information processing system 1 includes a remote control 10 (10A), a liquid crystal display 20 having a display screen, and an STB 30 that is an exemplary information processing device.

### [1-1. Configuration of Remote Control 10A]

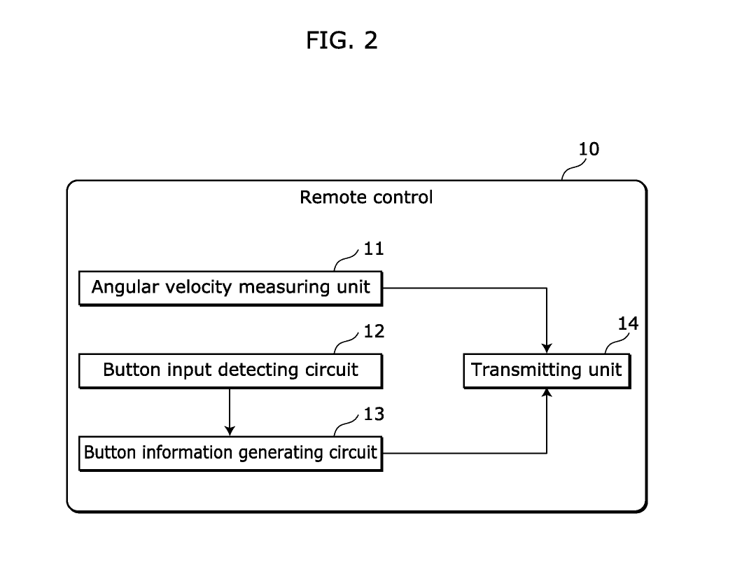

A configuration of the remote control 10A is described below based on FIG. 1 and FIG. 2. FIG. 2 is a block diagram showing an exemplary internal configuration of a remote control 10A.

The remote control 10A is for operating the STB 30. As shown in FIG. 1 and FIG. 2, the remote control 10A includes buttons, an angular velocity measuring unit 11, a button input detecting circuit 12, a button information generating circuit 13, and a transmitting unit 14.

The buttons are provided to a front surface of a case of the remote control 10A. In this embodiment, as shown in FIG. 1, the remote control 10A includes nine selection buttons Bs1 to Bs9, a power button Bp1, function buttons Bf1 to Bf3, and a mode switching button Bm1.

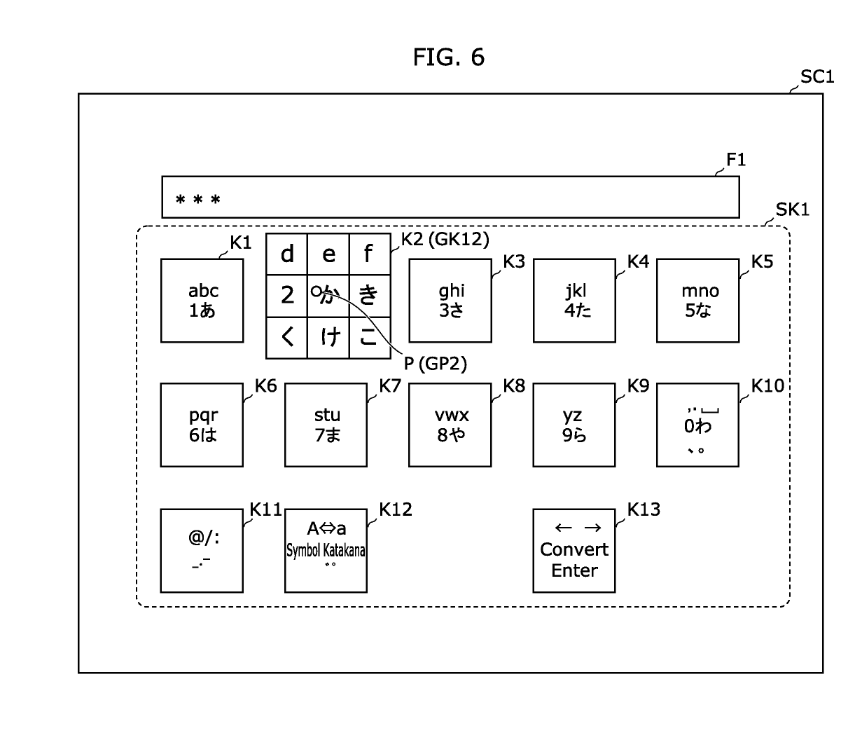

The selection buttons Bs1 to Bs9 are arranged in a 3×3 matrix, and each correspond to a different one of regions of an image GK12 (FIG. 6) of a key to be described later. The selection buttons Bs1 to Bs9 are designed so that a user can operate the remote control without looking at the remote control while watching only the display screen of the liquid crystal display 20. For instance, the central selection button Bs5 may have a greater recess than recesses of the other selection buttons or a specific button may include a projecting portion.

The power button Bp1 switches between ON and OFF of the STB30.

The function buttons Bf1 to Bf3 are function setting buttons. For example, display and non-display of the software keyboard is switched by pressing the function button Bf1

The mode switching button Bm1 is for switching a mode of the STB 30. Examples of the mode include a first mode in which an operation is performed using both angular velocity information and button information, and a second mode (cursor mode) in which an operation is performed using only the button information. It is to be noted that this embodiment describes a case where the STB 30 is set to the first mode.

The angular velocity measuring unit 11 measures an angular velocity. More specifically, for instance, the angular velocity measuring unit 11 measures, as an angular velocity, an acceleration rate for determining a motion amount in an x-axis direction (see FIG. 1) that is horizontal to the display screen of the liquid crystal display 20, and an acceleration rate for determining a motion amount in an y-axis direction (see FIG. 1). In FIG. 1, a lateral direction and a longitudinal direction of the display screen are referred to as the x-axis direction and the y-axis direction, respectively. Moreover, the angular velocity measuring unit 11 transmits angular velocity information indicating a measured angular velocity, to the STB 30 via the transmitting unit 14. It is to be noted that angular velocity information is an exemplary cursor operation.

The button input detecting circuit 12 detects a pressed button.

The button information generating circuit 13 generates button information indicating a pressed button, based on information from the button input detecting circuit 12. The button information generating circuit 13 transmits the generated button information to the STB 30 via the transmitting unit 14. It is to be noted that button information is an exemplary selection button operation.

The transmitting unit 14 is an interface for wirelessly communicating with the STB 30, and transmits, for example, angular velocity information and button information.

### [1-2. Configuration of Liquid Crystal Display 20]

The liquid crystal display 20 is an exemplary display device. Upon receiving a signal from the STB 30 to be described later, the liquid crystal display 20 displays, on the display screen, a menu scene, a character input scene, and so on. The character input scene is to be described later.

It is to be noted that in the following description, a position of a pixel on the display screen of the liquid crystal display 20 is represented by an orthogonal coordinate system, that is, the x-coordinate in the x-axis direction and the y-coordinate in the y-axis direction shown in FIG. 1. The top-left pixel has coordinates (0, 0).

### [1-3. Configuration of STB 30]

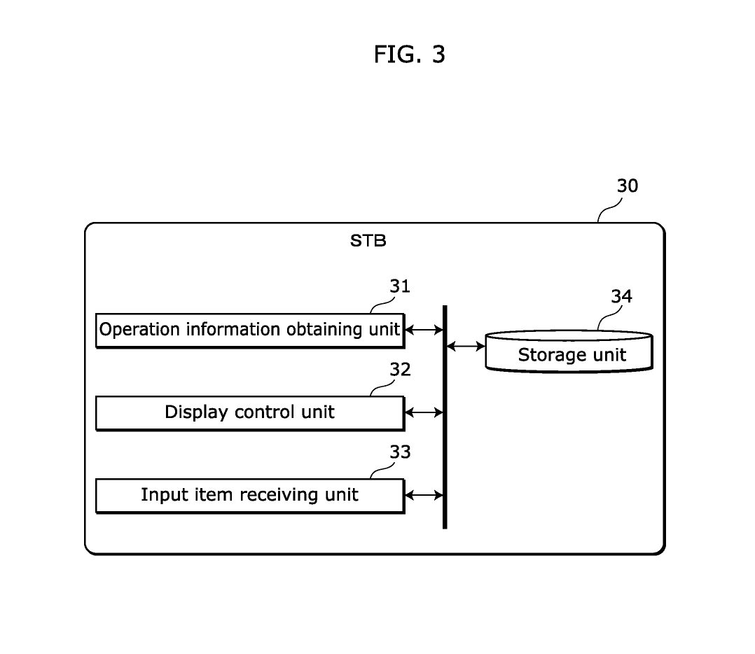

A configuration of the STB 30 is described below based on FIG. 3. FIG. 3 is a block diagram showing an exemplary configuration of the STB 30.

The STB 30 is an exemplary device capable of using ANDROID (registered trademark), and includes, as shown in FIG. 3, an operation information obtaining unit 31, a display control unit 32, an input item receiving unit 33, and a storage unit 34. It is to be noted that in this embodiment, the operation information obtaining unit 31, the display control unit 32, and the input item receiving unit 33 are implemented by, for instance, a central processing unit (CPU) executing a computer program (software) for performing the method for operating an information processing device according to this embodiment.

The operation information obtaining unit 31 receives angular velocity information and button information from the remote control 10 through wireless communication.

The display control unit 32 displays, on the display screen of the liquid crystal display 20, a character input scene including a character input field, a software keyboard, and a pointer, and controls display of the character input scene and the pointer based on operation information (a cursor operation and a selection button operation) from the remote control 10.

The software keyboard includes software keys (hereinafter appropriately abbreviated as “keys”) that are exemplary objects. Each of the keys is associated with input items. Moreover, each key is set to have a key range indicating a range for determining that a pointer P is on the key. The key range is represented by, for example, a range of the x-coordinate and a range of the y-coordinate that are set to the display screen of the liquid crystal display 20. In this embodiment, the display control unit 32 switches between images of the key and the pointer P depending on whether the pointer P is within the key range.

The display control unit 32 appropriately sets a display position of the pointer, e.g. the x, y coordinates, according to angular velocity information (an exemplary cursor operation) received from the operation information obtaining unit 31. For instance, if the angular velocity information includes an acceleration rate in the x-axis direction, the pointer is moved in the x-axis direction by a distance corresponding to the acceleration rate. If the angular velocity information includes an acceleration rate in the y-axis direction, the pointer is moved in the y-axis direction by a distance corresponding to the acceleration rate. In other words, the user can move the position of the pointer P by changing an angle (tilt) of the remote control 10 relative to the display screen.

If the operation information obtaining unit 31 receives button information when the pointer P is within the key range, the input item receiving unit 33 determines, among the input items corresponding to each key, an input item corresponding to the button information.

The storage unit 34 includes a given storage circuit such as a random-access memory (RAM) and a read-only memory (ROM). In this embodiment, the storage unit 34 stores the above-mentioned computer program, information about a character input scene, an image of the pointer, an image of the software keyboard, and so on. Examples of the information about the character input scene include a size and an arrangement of the character input scene. The image of the software keyboard includes the image of each key.

### [1-4. Character Input Scene]

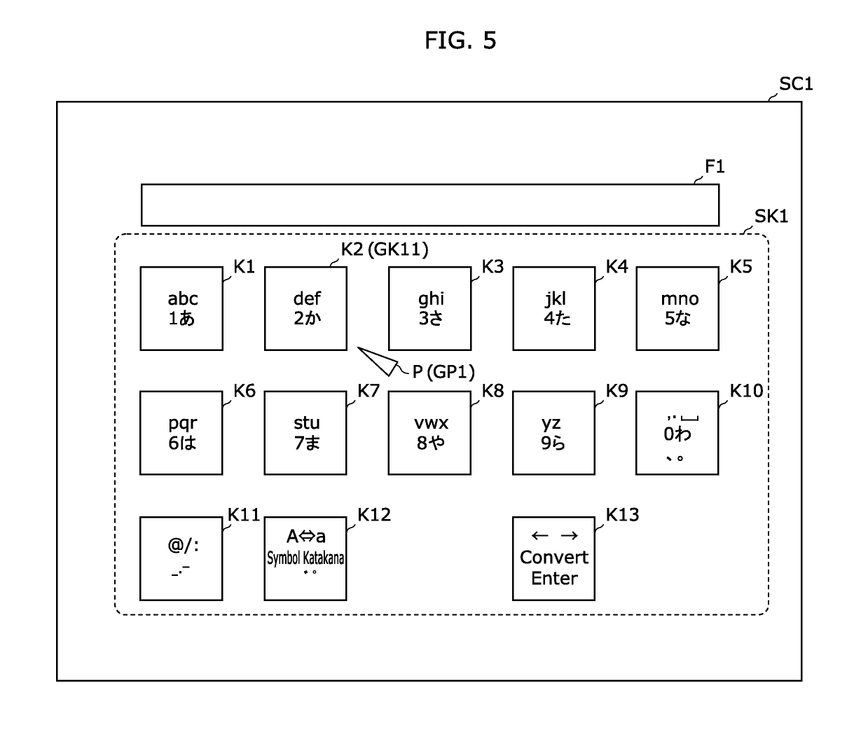

Elements of a character input scene that the STB 30 displays on the display screen of the liquid crystal display 20 are described below based on FIG. 5 and FIG. 6.

It is to be noted that the elements of the character input scene differ between a case where the pointer P is out of a key range and a case where the pointer P is within the key range.

First, a character input scene when the pointer P is out of the key range is described below based on FIG. 5. FIG. 5 is a diagram showing an exemplary character input scene when the pointer P is out of a key range.

A character input scene SC1 shown in FIG. 5 shows a character input field F1, a software keyboard SK1, and the pointer P.

The character input field F1 is a region showing a character specified through an operation on the remote control 10. The character input field F1 shows a cursor indicating a position at which a character is input, in addition to the character specified through the operation on the remote control 10.

The software keyboard SK1 is displayed on the display screen, and includes keys K1 to K13 (corresponding to exemplary objects). The user inputs a character by operating the remote control 10 to designate, with the pointer P, a key associated with the character the user wants to input.

In the character input scene SC1, a size and an arrangement of the keys K1 to K13 are set according to the operability of the remote control 10.

Here, as stated above, the user can move the position of the pointer P by changing the angle of the remote control 10 relative to the display screen. If the user operates the remote control 10 with one hand, an angle of the remote control 10 which can be easily changed is thought to be an angle of approximately 45 degrees at most, though there are differences between individuals. For this reason, in this embodiment, in the case where the remote control 10 is at a predetermined reference position relative to the display screen of the liquid crystal display 20, the software keyboard SK1 is designed to have a width corresponding to an angle of 45 degrees or less of the remote control 10. The reference position is set within a range in which the remote control 10 is capable of transmitting button information and angular velocity information to the operation information obtaining unit 31 of the STB 30, for instance.

Moreover, if hand movement is not considered, to keep the pointer P on a key, the key has, for example, a width corresponding to an angle of approximately 4 degrees of the remote control. Furthermore, a variation in angle caused by the hand movement is thought to be an angle of approximately 1 degree. Accordingly, to prevent the pointer P from moving beyond a key range due to hand movement when a button is operated, each key has, for example, a width corresponding to an angle of 4 degrees+(1 degree×2)=6 degrees or more of the remote control 10.

Thus, if the operability is considered, the maximum number of keys that can be arranged in a row is 45/6=7. In the character input scene SC1 shown in FIG. 5, each key is designed to have a width corresponding to an angle of 6 degrees of the remote control 10, and a maximum of five keys are arranged in a row. Moreover, to reduce erroneous determination of a position of the pointer P, a space corresponding to an angle of 3 degrees is provided between adjacent keys. Specifically, in the character input scene SC1 shown in FIG. 5, the keys K1 to K5, the keys K6 to K10, and the keys K11 to K13 are arranged in the first row, the second row, and the third row from the top, respectively.

Each of the keys K1 to K13 corresponds to different input items. In this embodiment, the input items include a character such as an English alphabet, a numeral, a kana, and a symbol, and functions such as switch of a character type, cursor movement, conversion, and entering.

More specifically, each of the keys K1 to K10 corresponds to three English alphabets, one numeral, three to five kanas of one column of the kana syllabary. For instance, the key K1 corresponds to the English alphabets “a,” “b,” and “c,” the numeral “1,” and the “ [symbol] ” column of the kana syllabary. The key K2 corresponds to the English alphabets “d,” “e,” and “f,” the numeral “2,” and the “ [symbol] ” column of the kana syllabary. The key K11 corresponds to symbols. The key K12 corresponds to a switch of a character type. Examples of the switch of a character type include switch between a large character and a small character, switch between hiragana and katakana, and switch between a unvoiced consonant, a voiced consonant, and a p-sound in the kana syllabary. The key K13 corresponds to functions such as a rightward movement of a cursor position in the character input field F1, a leftward movement of a cursor position in the character input field F1, conversion from kana to kanji or the like, and entering.

Each of images GK11 of the keys K1 to K13 includes one region and shows characters (figure) representing the associated characters. For example, the image of the key K1 shows “abc1 [symbol] ,” and the image GK11 of the key K2 shows “def2 [symbol] .” The whole images of the respective keys K1 to K13 are key ranges.

The pointer P indicates a position, which is indicated by the remote control 10, on the display screen of the liquid crystal display 20. If the pointer P is out of a key range, the pointer P is represented by an isosceles triangle arrow image GP1 as shown in FIG. 5. The tip of the arrow corresponds to a position (coordinates) of the pointer P.

Next, a character input scene when the pointer P is within the key range is described below based on FIG. 6. FIG. 6 shows a case where the pointer P is within a key range of the key K2.

A character input scene SC1 shown in FIG. 6 shows a character input field F1, a software keyboard SK1, and the pointer P.

The character input field F1 is the same as the one shown in FIG. 5.

The software keyboard SK1 differs from the one shown in FIG. 5 in the key K2 on which the pointer P is. In FIG. 6, an image of the key K2 when the pointer P is within the key range of the key K2 is an image GK12.

In this embodiment, the image GK12 is larger than the image GK11. In this embodiment, the image GK12 is designed to have the maximum size in a state where an arrangement of the keys K1 and K3 to K13 is not changed and a space necessary for reducing erroneous determination of a position of the pointer P is maintained between the key K2 and the adjacent keys K1, K7, and K3. Specifically, in the character input scene SC1 shown in FIG. 6, the image GK12 of the key K2 is designed to correspond in size to an angle of 9 degrees of the remote control 10.

As shown in FIG. 6, the image GK12 of the key includes regions. The number and an arrangement of the regions correspond one-to-one to the number and arrangement of the selection buttons Bs1 to Bs9 of the remote control 10. In this embodiment, since the remote control 10 includes the nine selection buttons Bs1 to Bs9, the image GK12 includes the nine regions. Moreover, since the nine selection buttons Bs1 to Bs9 are arranged in the 3×3 matrix, the image GK12 includes nine equal-size rectangles that are arranged in the 3×3 matrix. In other words, the image GK12 is obtained by dividing one rectangle by 3 rows and 3 columns. Since the image GK12 is designed to have a width corresponding to the angle of 9 degrees of the remote control 10, a width of each of the regions corresponds to an angle of 9/3=3 degrees of the remote control 10.

One input item is assigned to each of the regions. For example, the key K2 is associated with the input items “d,” “e,” “f,” “2,” “ [symbol] ,” “ [symbol] ,” “ [symbol] ,” “ [symbol] ,” and “ [symbol] .” “d” is assigned to the top-left region corresponding to the selection button Bs1. “e” is assigned to the top-middle region corresponding to the selection button Bs2. “f” is assigned to the top-right region corresponding to the selection button Bs3. “2” is assigned to the left-middle region corresponding to the selection button Bs4. “ [symbol] ” is assigned to the middle region corresponding to the selection button Bs5. “ [symbol] ” is assigned to the right-middle region corresponding to the selection button Bs6. “ [symbol] ” is assigned to the bottom-left region corresponding to the selection button Bs7. “ [symbol] ” is assigned to the bottom-middle region corresponding to the selection button Bs8. “ [symbol] ” is assigned to the bottom-right region corresponding to the selection button Bs9. It is to be noted that if the pointer P is within the key range of one of the keys K1 and K3 to K13, an image corresponding to the image GK12 of the key K2 is displayed.

It is to be noted that the whole image (including all of the nine regions) of the key K2 is a key range.

If the pointer P is within any key range, the pointer P is represented by a circular dot image GP2 shown in FIG. 6. Changing the image of the pointer P to the dot image GP2 smaller than the arrow image GP1 allows the user to more easily view the image of any key on which the pointer P is.

### [1-5. Operation of STB 30]

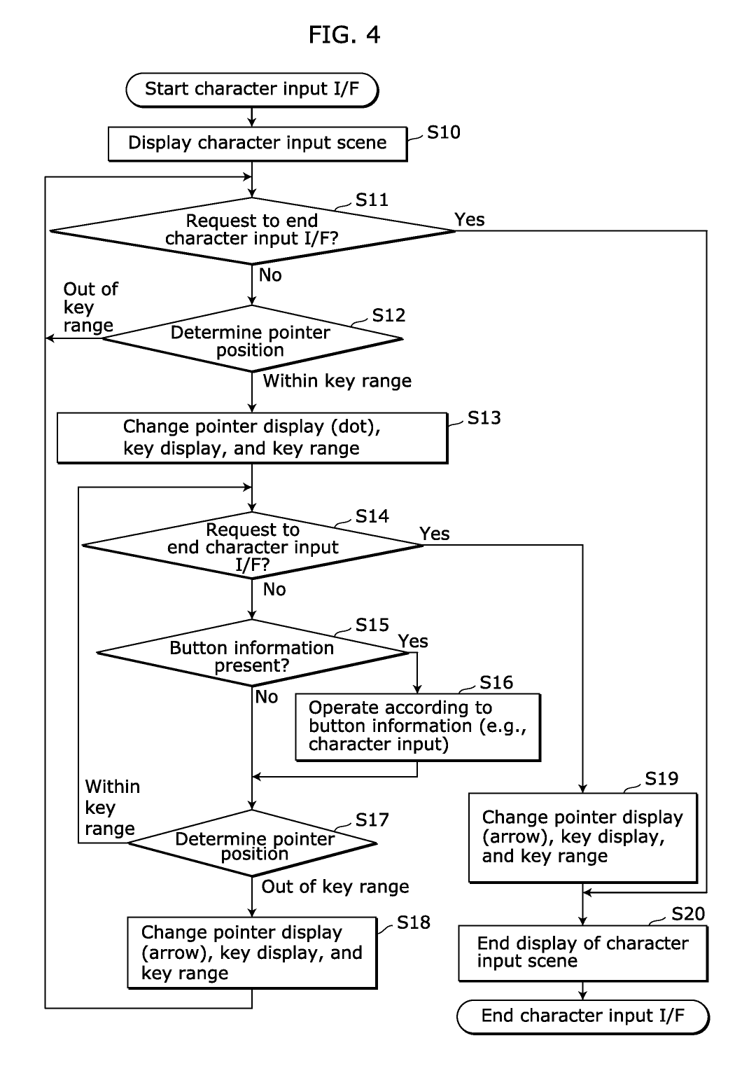

An operation of the STB 30 is described below based on FIG. 4 to FIG. 6.

FIG. 4 is a flow chart showing an exemplary procedure of the method for operating an information processing device, which is performed by the STB 30.

When a character input interface (I/F) is started, the display control unit 32 of the STB 30 displays a character input scene on the display screen of the liquid crystal display 20 (S10).

In step S10, the display control unit 32 displays, on the display screen of the liquid crystal display 20, the character input scene SC1 shown in FIG. 5. At this time, the pointer P has an arrow shape (isosceles triangle shape).

Moreover, the display control unit 32 sets, for each of the keys K1 to K13, a key range indicating a range for determining that the pointer P is on a key. In this embodiment, the key ranges are the same as a range displaying an image GK11 of a key. In step S10, the same range as the range of the image GK11 is set as the key ranges for all of the keys K1 to K13.

After displaying the character input scene SC1 shown in FIG. 5, the STB 30 determines whether there is a request to end character input (S11).

If the STB 30 determines that the request to end the character input is present in step S11 (“Yes” in S11), the STB 30 ends the display of the character input scene SC1 (S20) and terminates the character input I/F.

If the STB 30 determines that there is no request to end the character input in step S11 (“No” in S11), the STB 30 determines a position of the pointer P (S12). In this step, since the first determination of the position of the pointer P or the last determination of the position of the pointer P shows that the pointer P is out of a key range, the STB 30 performs the determination for the keys K1 to K13 using the respective key ranges corresponding in size to the images GK11.

If the pointer P is out of any key range (“Out of key range” in S12), the STB 30 returns to step S11.

If the pointer P is within any key range (“Within key range” in S12), the display control unit 32 of the STB 30 changes display of the pointer P and one of the keys which corresponds to the key range, to change the key range (S13). Hereinafter, a case is described where the pointer P is within the key range of the key K2.

Specifically, the display control unit 32 changes the image of the pointer P from the arrow image GP1 shown in FIG. 5 to the circular dot image GP2 shown in FIG. 6. Changing the image of the pointer P to the dot image GP2 smaller than the arrow image GP1 allows the user to more easily view the image of the key on which the pointer P is.

Moreover, the display control unit 32 changes the image of the key on which the pointer P is from the image GK11 shown in FIG. 5 to the image GK12 shown in FIG. 6.

Furthermore, the display control unit 32 changes the key range of the key on which the pointer P is from the range of the image GK11 to the range (range including all of the nine regions) of the image GK12. Since the image GK12 is larger than the image GK11, if the pointer P is within the key range, the key range increases in size.

After displaying the character input scene SC1 shown in FIG. 6, the STB 30 determines whether there is a request to end character input (S14).

If the STB 30 determines that the request to end the character input is present in step S14 (“Yes” in S14), the STB 30 changes the character input scene SC1 shown in FIG. 6 to the character input scene SC1 shown in FIG. 5, ends the display of the character input scene SC1 (S20), and terminates the character input I/F. It is to be noted that the STB 30 may end the display of the character input scene SC1 shown in FIG. 6 without returning it to the character input scene SC1 shown in FIG. 5.

If the STB 30 determines that there is no request to end the character input in step S14 (“No” in S14), the STB 30 determines whether button information indicating a pressed button is present (S15)

If the STB 30 determines that the button information is present (“Yes” in S15), that is, if the STB receives a selection button operation, the STB 30 performs an operation according to the button information (S16). For instance, if the button information is information indicating that any one of the selection buttons Bs1 to Bs9 has been pressed, the input item receiving unit 33 of the STB 30 specifies a character corresponding to the pressed selection button and displays the character in the character input field F1. For example, if the selection button Bs1 is pressed when the pointer P is within the key range of the key K2 as shown in FIG. 6, the display control unit 32 specifies “d” at the corresponding position and displays “d” in the character input field F1. Likewise, if any one of the selection buttons Bs2 to Bs9 is pressed, the display control unit 32 specifies a corresponding one of “e,” “f,” “2,” “ [symbol] ,” “ [symbol] ,” “ [symbol] ,” “ [symbol] ,” and “ [symbol] ” at the corresponding positions and displays the corresponding one of “e,” “f,” “2,” “ [symbol] ,” “ [symbol] ,” “ [symbol] ,” “ [symbol] ,” and “ [symbol] ” in the character input field F1.

After determining whether button information is present (S15) and performing an operation according to the button information (S16), the STB 30 determines a position of the pointer P (S17). Here, for instance, since the last determination shows that the pointer P is within the key range of the key K2, the STB 30 performs the determination for the key K2 using the key range corresponding in size to the image GK12. Moreover, the STB 30 performs the determination for the keys K1 and K3 to K13 using the respective key ranges corresponding in size to the images GK11.

If the pointer P is within the key range (“Within key range” in S17), the STB 30 returns to step S14. If any of the selection buttons Bs1 to Bs9 are continuously pressed without moving the pointer P, configuring the STB 30 as steps S14 to S17 enables continuous input of the characters corresponding to any of the pressed selection buttons. In other words, only the simple operation, the continuous operation of the selection buttons Bs1 to Bs9, enables the continuous input of the characters.

If the pointer P is out of the key range (“Out of key range” in S17), the display control unit 32 of the STB 30 changes a scene on the display screen of the liquid crystal display 20 from the character input scene SC1 shown in FIG. 6 to the character input scene SC1 shown in FIG. 5, and the STB 30 returns to step S11 (S18).

More specifically, the display control unit 32 changes the image of the pointer P from the circular dot image GP2 shown in FIG. 6 to the arrow image GP1 shown in FIG. 5. Moreover, the display control unit 32 changes the image of the key K2 from the image GK12 shown in FIG. 6 to the image GK11 shown in FIG. 5.

Furthermore, the display control unit 32 changes the key range from the range of the image GK12 to the range of the image GK11.

### [1-6. Modification]

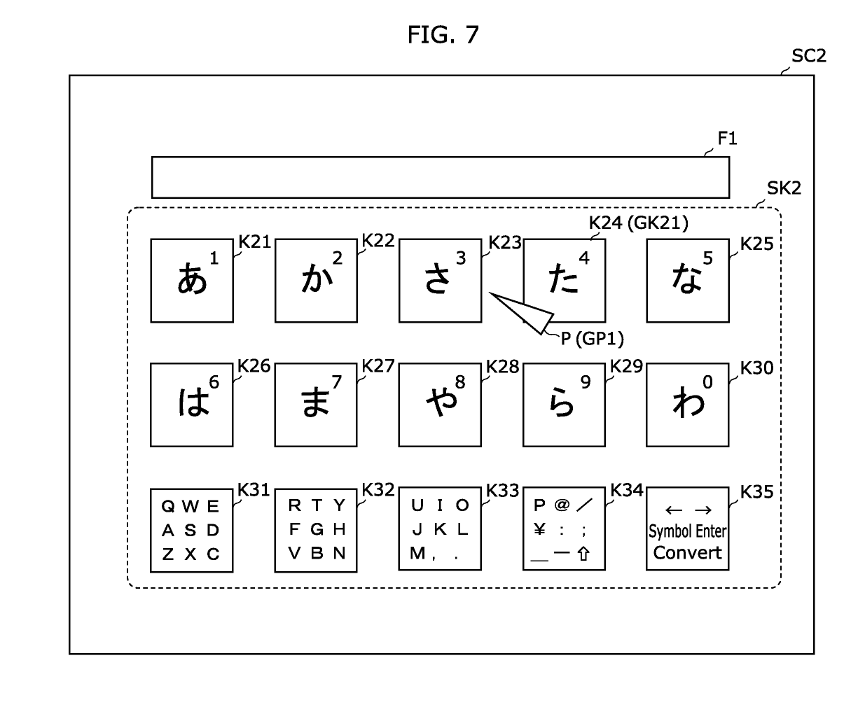

The following describes a modification of Embodiment 1 based on FIG. 7 to FIG. 9.

This modification describes a different character input scene, particularly a different configuration of the software keyboard.

First, a character input scene when a pointer P is out of a key range is described below based on FIG. 7. FIG. 7 is a diagram showing an exemplary character input scene SC2 in this modification.

The character input scene SC2 shown in FIG. 7 shows a character input field F1, a software keyboard SK2, and the pointer P.

Display of the character input field F1 and the pointer P is the same as in Embodiment 1.

The software keyboard SK2 includes keys K21 to K35 (corresponding to exemplary objects).

In the character input scene SC2, a size and an arrangement of the keys are set according to the operability of the remote control 10 in the same manner as the character input scene SC1. More specifically, the number of keys arranged in one row is five, and a width of each of the keys and an interval between the keys are the same as those in the character input scene SC1. In the character input scene SC2 shown in FIG. 7, the keys K21 to K25, the keys K26 to K30, and the keys K31 to K35 are arranged in the first row, the second row, and the third row from the top, respectively.

Each of the keys K21 to K35 corresponds to different input items. More specifically, each of the keys K21 to K30 corresponds to one numeral and six kanas of one column of the kana syllabary, a switch to small character (only for the column including a kana switchable to a small character), and a switch to voiced consonant, p-sound in the kana syllabary, or unvoiced consonant (only for the column of corresponding kanas). For example, the key K21 corresponds to the numeral “1” and the “ [symbol] ” column of the kana syllabary. Moreover, the key K31 corresponds to the nine English alphabets “Q,” “W,” “E,” “A,” “S,” “D,” “Z,” “X,” and “C.” Likewise, the key K32 corresponds to nine English alphabets. The key K33 corresponds to seven English alphabets and two symbols. The key K34 corresponds to nine symbols. The key K35 corresponds to functions such as a rightward movement of a cursor position in the character input field F1, a leftward movement of a cursor position in the character input field F1, conversion from kana to kanji or the like, and entering.

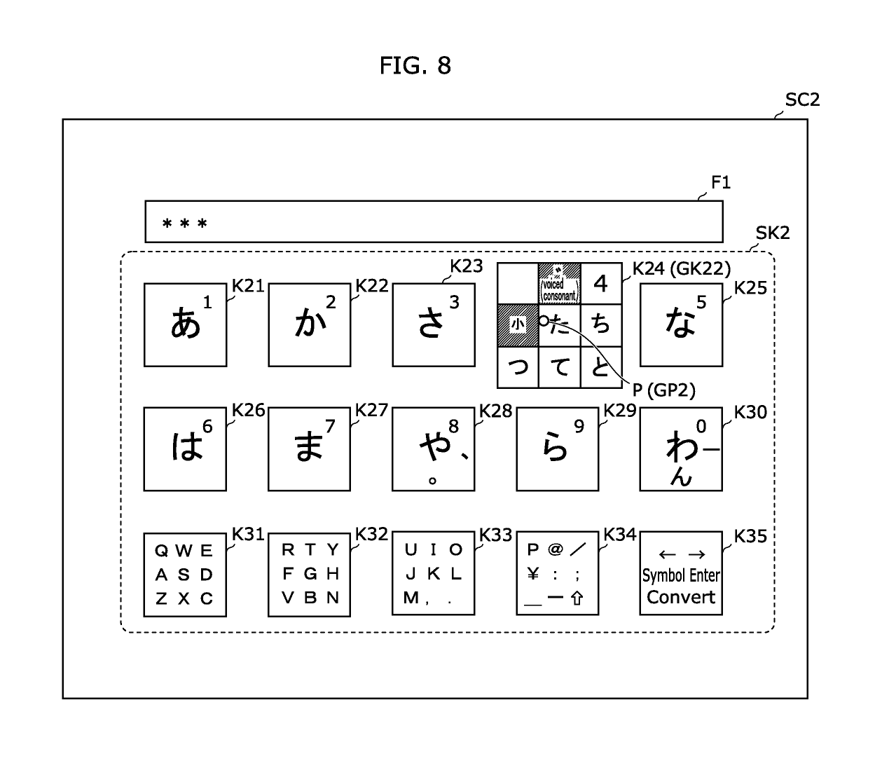

Next, a character input scene when the pointer P is within a key range is described below based on FIG. 8. FIG. 8 is a diagram showing an exemplary character input scene SC2 in this modification. FIG. 8 shows a case where the pointer P is within a key range of the key K24.

The character input scene SC2 shown in FIG. 8 shows a character input field F1, a software keyboard SK2, and the pointer P.

Display of the character input field F1 and the pointer P is the same as in Embodiment 1.

If the pointer P moves into the key range of the key K24, the display control unit 32 changes an image of the key K24 from an image GK21 shown in FIG. 7 to an image GK22 shown in FIG. 8.

The image GK22 of the key K24 when the pointer P is within the key range of the key K24 is larger than the image GK21 of the key K24 when the pointer is out of the key range of the key K24. It is to be noted that the image GK22 has the same size as the image GK12 shown in FIG. 6.

In this modification, as shown in FIG. 8, the image GK22 of the key includes regions. The number and an arrangement of the regions correspond one-to-one to the number and arrangement of the selection buttons Bs1 to Bs9 of the remote control 10 in the same manner as in Embodiment 1.

One input item is assigned to each of the regions. For instance, the key K24 is associated with input items such as the switch to voiced consonant, “4,” “ [symbol] ” that represents the switch to small character, and “ [symbol] ,” “ [symbol] ,” “ [symbol] ,” “ [symbol] ,” and “ [symbol] ,” which correspond to the selection buttons Bs2 to Bs9, respectively. It is to be noted that nothing is assigned to the top-left region corresponding to the selection button Bs1. In the case of a selection button for the “ [symbol] ” column of the kana syllabary, p-sound in the kana syllabary may be assigned to the top-left region of the selection button.

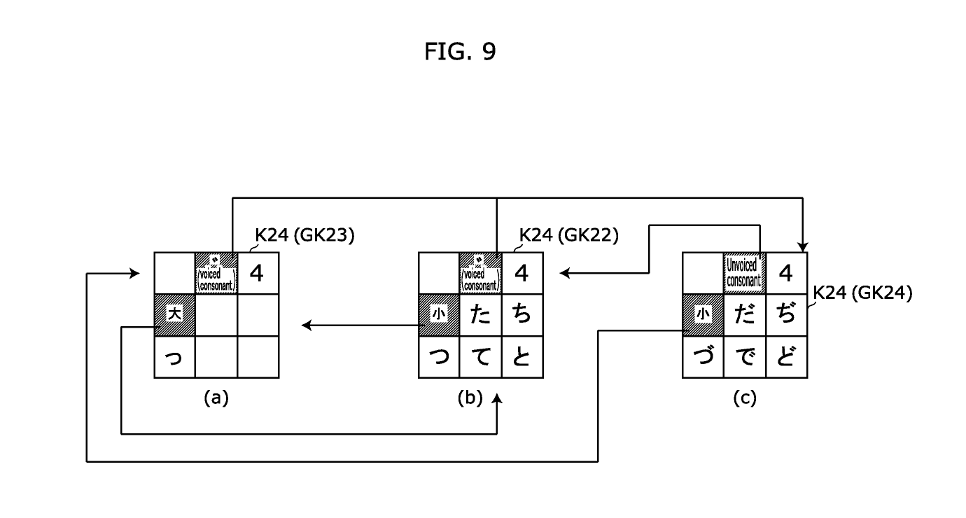

FIG. 9 is a diagram showing an exemplary transition of an image of a key when the pointer P is within a key range.

(a) of FIG. 9 shows an exemplary image GK23 of the key when input of a small character is selected. (b) of FIG. 9 shows the same image as the image GK22 of the key K24 shown in FIG. 8. (c) of FIG. 9 shows an exemplary image GK24 of the key when input of a voiced consonant is selected.

In the image GK23 shown in (a) of FIG. 9, “ [symbol] ” to be switched to a small character is kept, and the other characters of the “ [symbol] ” column of the kana syllabary are not shown. In the image GK24 shown in (c) of FIG. 9, the characters of the “ [symbol] ” column of the kana syllabary are replaced with voiced consonants of the “ [symbol] ” column of the kana syllabary.

The following describes a method for switching between images of a key in the character input scene SC2, which is performed by the display control unit 32.

When the pointer P moves into the key range of the key K24 in the case where the character input scene SC2 shown in FIG. 7 is displayed, as shown in FIG. 8, the display control unit 32 switches the image of the key K24 from the image GK21 shown in FIG. 7 to the image GK22 ((b) of FIG. 9) shown in FIG. 8.

If the selection button Bs4 is pressed in a state where the image GK22 shown in (b) of FIG. 9 or the image GK24 shown in (c) of FIG. 9 is displayed, since the selection button Bs4 corresponds to the region to which the switch to small character is assigned, the display control unit 32 switches the image of the key K24 to the image GK23 shown in (a) of FIG. 9.

If the selection button Bs2 is pressed in a state where the image GK22 shown in (b) of FIG. 9 or the image GK23 shown in (a) of FIG. 9 is displayed, since the selection button Bs2 corresponds to the region to which the switch to voiced consonant is assigned, the display control unit 32 switches the image of the key K24 to the image GK24 shown in (c) of FIG. 9.

If the selection button Bs4 is pressed in a state where the image GK23 shown in (a) of FIG. 9 is displayed, since the selection button Bs4 corresponds to the region to which the switch to large character is assigned, the display control unit 32 switches the image of the key K24 from the image GK23 to the image GK22 shown in (b) of FIG. 9.

If the selection button Bs2 is pressed in a state where the image GK24 shown in (c) of FIG. 9 is displayed, since the selection button Bs2 corresponds to the region to which the switch to unvoiced consonant is assigned, the display control unit 32 switches the image of the key K24 from the image GK24 to the image GK22 shown in (b) of FIG. 9.

If any of the selection buttons Bs3 and Bs5 to Bs9 is pressed in a state where one of (a) to (c) of FIG. 9 is displayed, the input item receiving unit 33 displays the corresponding character at a cursor position in the character input field F1.

### [1-7. Effects]

The information processing device (STB 30) according to this embodiment performs the object selection (key selection) by using the angle of the remote control 10 in combination with the input item specification through the button operation on the remote control 10. For this reason, with the information processing device according to this embodiment, bringing the pointer P onto the relatively small region such as “d” and “e” is not required, and the pointer P may be brought onto the image GK12 of the relatively large key. In other words, with the information processing device according to this embodiment, since a range of a region onto which the pointer P is brought is wide, it is possible to reduce the number of wrong inputs caused by hand movement.

Moreover, since the character specification is performed through the button operation on the remote control 10, it is possible to suppress an increase in the number of button operations. In particular, if characters associated with the same object (key) are continuously input, it is possible to expect a reduction in the number of button operations.

Furthermore, with the information processing device according to this embodiment, since the image GK12 of the key displayed when the pointer P is within the key range corresponds to the number and arrangement of the selection buttons Bs1 to Bs9 of the remote control 10, the user can easily understand the correspondence relationship between the selection buttons and the characters to be input.

Moreover, with the information processing device according to this embodiment, since the image GK12 of the key displayed when the pointer P is within the key range is larger than the image GK11 of the key displayed when the pointer P is out of the key range, it is possible to reduce the number of the wrong inputs caused by the hand movement.

### Embodiment 2

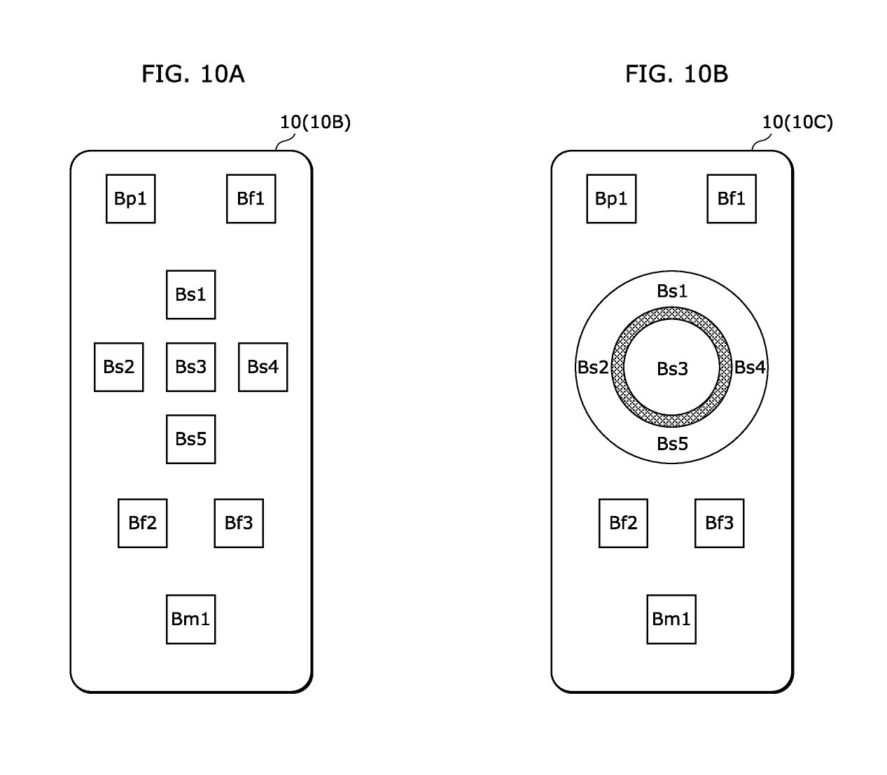

An information processing device, a method for operating an information processing device, and an information processing system according to Embodiment 2 are described below based on FIG. 10A to FIG. 14.

In this embodiment, a case is described where the number and an arrangement of the selection buttons of the remote control 10 are different from those in Embodiment 1.

As with the information processing system 1 according to Embodiment 1 shown in FIG. 1, the information processing system according to this embodiment includes a remote control 10, a liquid crystal display 20 having a display screen, and an STB 30 that is an exemplary information processing device.

It is to be noted that the liquid crystal display 20 and the STB 30 are the same as those in Embodiment 1 except elements of a character input scene to be displayed.

### [2-1. Configuration of Remote Control 10B]

A configuration of a remote control 10B is described below based on FIG. 10A. FIG. 10A is diagram showing an exemplary remote control 10 according to this embodiment.

The remote control 10B is for operating the STB 30. It is to be noted that an internal configuration of the remote control 10B is the same as that of the remote control 10A in Embodiment 1 shown in FIG. 2 except a difference in the number of selection buttons. The remote control 10B includes buttons, an angular velocity measuring unit 11, a button input detecting circuit 12, a button information generating circuit 13, and a transmitting unit 14. It is to be noted that the angular velocity measuring unit 11 and the transmitting unit 14 are the same as those in Embodiment 1. Moreover, the button input detecting circuit 12 and the button information generating circuit 13 are the same as those in Embodiment 1 except a difference in the number of button detected and a difference that the number of pieces of button information generated is less.

The buttons are provided to a front surface of a case of the remote control 10B. In this embodiment, as shown in FIG. 10A, the remote control 10B includes five selection buttons Bs1 to Bs5, a power button Bp1, function buttons Bf1 to Bf3, and a mode switching button Bm1. The power button Bp1, the function buttons Bf1 to Bf3, and the mode switching button Bm1 are the same as those in Embodiment 1.

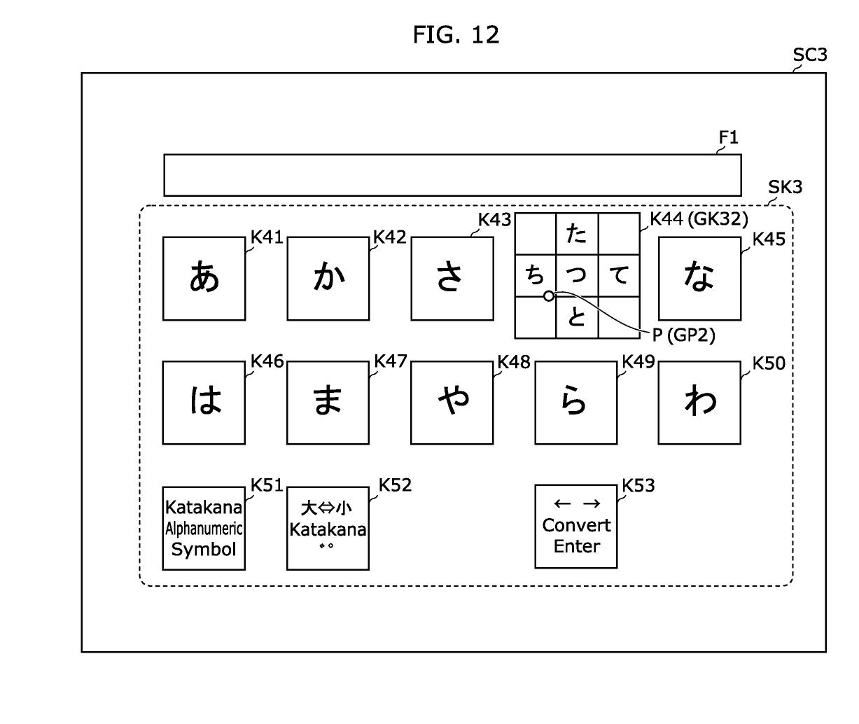

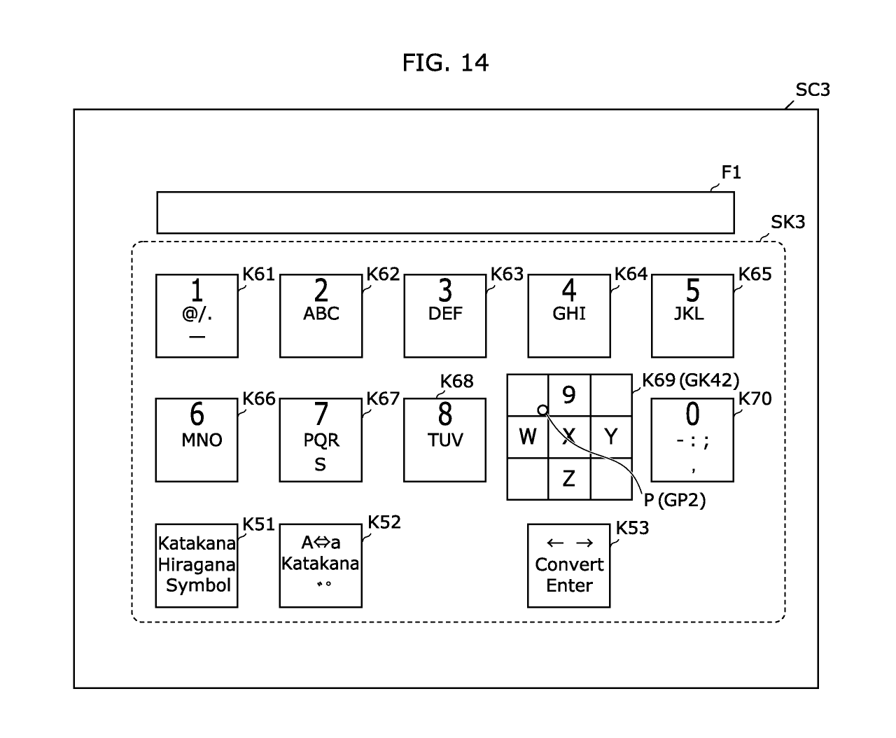

In this embodiment, the selection buttons Bs1 to Bs5 are arranged in a cross shape, and correspond to regions of each of images GK32 (FIG. 12) and GK42 (FIG. 14) of a key to be described later. The selection buttons Bs1 to Bs5 are designed so that a user can operate the remote control without looking at the remote control while watching only the display screen of the liquid crystal display 20.

### [2-2. Character Input Scene]

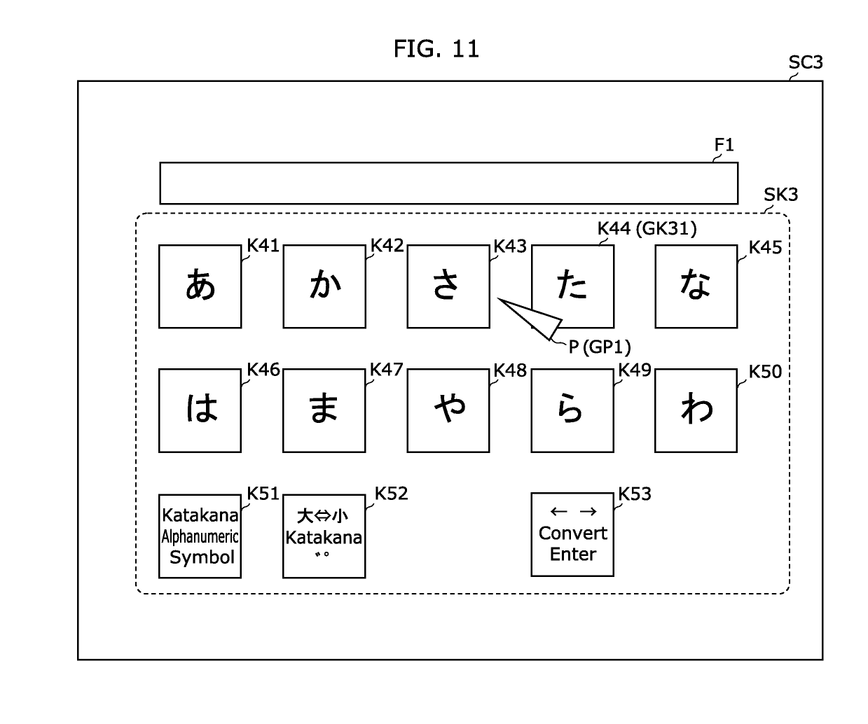

Elements of a character input scene in this embodiment are described below based on FIG. 11 to FIG. 13.

It is to be noted that in a character input scene SC3 in this embodiment, a software keyboard SK3 includes input modes including a kana input mode for inputting kana and an English alphabet input mode for inputting English alphabet. Moreover, the elements of the character input scene SC3 in this embodiment differ between a case where the pointer P is out of a key range and a case where the pointer P is within the key range.

### [2-2-1. Kana Input Mode]

The following describes the elements of the software keyboard SK3 in the kana input mode.

First, a case where the pointer P is out of the key range is described below based on FIG. 11. FIG. 11 is a diagram showing an exemplary character input scene SC3 when the pointer P is out of the key range.

The character input scene SC3 shown in FIG. 11 shows the character input field F1, the software keyboard SK3, and the pointer P.

The character input field F1 and the pointer P are the same as those in Embodiment 1 (FIG. 5).

The software keyboard SK3 includes keys K41 to K53 (corresponding to exemplary objects) in the kana input mode.

In the character input scene SC3, a size and an arrangement of the keys are set according to the operability of the remote control 10 in the same manner as the character input scenes SC1 and SC2. More specifically, the number of keys arranged in one row is five, and a width of each of the keys and an interval between the keys are the same as those in the character input scenes SC1 and SC2. In the character input scene SC3 shown in FIG. 11, the keys K41 to K45, the keys K46 to K50, and the keys K51 to K53 are arranged in the first row, the second row, and the third row from the top, respectively.

Each of the keys K41 to K50 corresponds to different input items. More specifically, each of the keys K41 to K50 corresponds to five kanas of one column of the kana syllabary. For instance, the key K41 corresponds to the “ [symbol] ” column of the kana syllabary. Moreover, the key K51 corresponds to a switch of an input mode. Examples of the input mode include a hiragana input mode, a katakana input mode, the English alphabet input mode, and a symbol input mode. The input mode is switched sequentially by selecting the key K51. The key K52 corresponds to a switch between large character and small character (only for the column including a kana switchable to a small character) and a switch between voiced consonant, p-sound in the kana syllabary, and unvoiced consonant (only for the column of corresponding kanas). The key K53 corresponds to functions such as a rightward movement of a cursor position in the character input field F1, a leftward movement of a cursor position in the character input field F1, conversion from kana to kanji or the like, and entering.

Next, the character input scene SC3 when the pointer P is within a key range is described below based on FIG. 12. FIG. 12 is diagram showing an exemplary character input scene SC3 in this embodiment. FIG. 12 shows a case where the pointer P is within a key range of the key K44.

The character input scene SC3 shown in FIG. 12 shows the character input field F1, the software keyboard SK3, and the pointer P.

The character input field F1 and the pointer P are the same as those in Embodiment 1 (FIG. 6).

If the pointer P moves into the key range of the key K44, the display control unit 32 changes an image of the key K44 from an image GK31 shown in FIG. 11 to an image GK32 shown in FIG. 12.

The image GK32 of the key K44 when the pointer P is within the key range of the key K44 is larger than the image GK31 of the key K44 when the pointer is out of the key range of the key K44. It is to be noted that the image GK32 has the same size as the image GK12 shown in FIG. 6.

In this embodiment, as shown in FIG. 12, the image GK32 of the key includes regions. The number and an arrangement of the regions correspond one-to-one to the number and arrangement of the selection buttons Bs1 to Bs5 of the remote control 10.

One input item is assigned to each of the regions. For example, the key K44 is associated with the input items “ [symbol] ,” “ [symbol] ,” “ [symbol] ,” “ [symbol] ,” and “ [symbol] ” which correspond to the selection buttons Bs1 to Bs5. It is to be noted that since there are no selection buttons corresponding to the top-left, bottom-left, top-right, and bottom-right regions, nothing is assigned to these regions.

### [2-2-2. English Alphabet Input Mode]

The following describes the elements of the software keyboard SK3 in the English alphabet input mode.

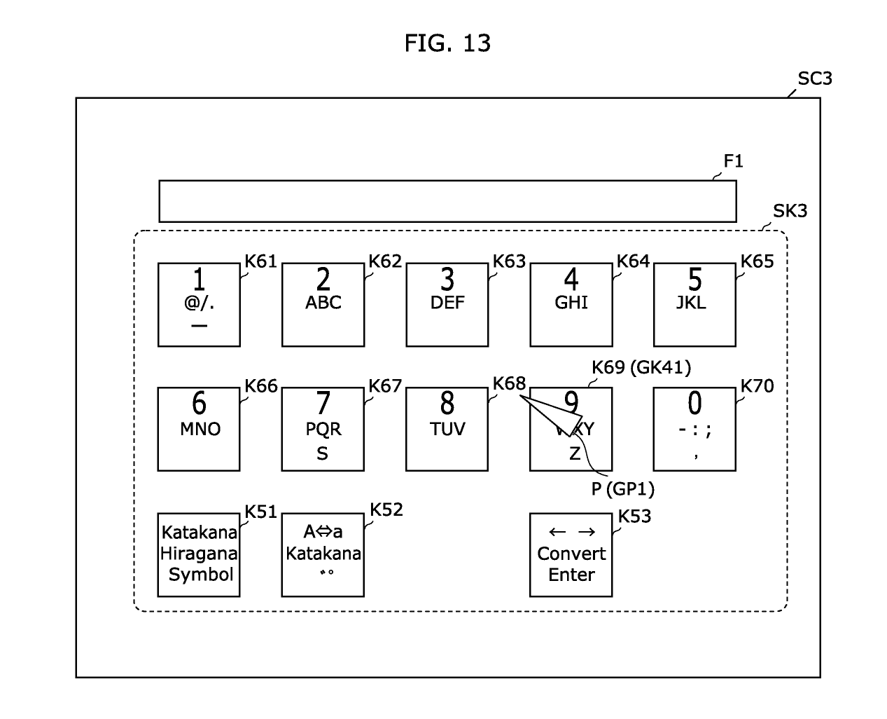

First, a case where the pointer P is out of a key range is described below based on FIG. 13. FIG. 13 is a diagram showing an exemplary character input scene SC3 in the case where the pointer P is out of the key range.

The character input scene SC3 shown in FIG. 13 shows the character input field F1, the software keyboard SK3, and the pointer P.

The character input field F1 and the pointer P are the same as those in Embodiment 1 (FIG. 5).

The software keyboard SK3 includes keys K61 to K70 and K51 to K53 (corresponding to exemplary objects) in the English alphabet input mode.

A size and an arrangement of the keys in the character input scene SC3 are the same as those in the kana input mode. In the character input scene SC3 shown in FIG. 13, the keys K61 to K65, the keys K66 to K70, and the keys K51 to K53 are arranged in the first row, the second row, and the third row from the top, respectively.

Each of the keys K61 to K70 corresponds to different input items. More specifically, the key K61 corresponds to one numeral and symbols such as @ and /. Each of the keys K62 to K69 corresponds to one numeral and three or four English alphabets. For instance, the key K61 corresponds to “2,” “A,” “B,” and “C.” Correspondences of the keys K51 to K53 are the same as those in the kana input mode.

Next, the character input scene SC3 when the pointer P is within a key range is described below based on FIG. 14. FIG. 14 is diagram showing an exemplary character input scene SC3 in this embodiment. FIG. 14 shows a case where the pointer P is within a key range of the key K69.

The character input scene SC3 shown in FIG. 14 shows the character input field F1, the software keyboard SK3, and the pointer P.

The character input field F1 and the pointer P are the same as those in Embodiment 1 (FIG. 6).

If the pointer P moves into the key range of the key K69, the display control unit 32 changes an image of the key K69 from an image GK41 shown in FIG. 13 to an image GK42 shown in FIG. 14.

The image GK42 of the key K69 when the pointer P is within the key range of the key K69 is larger than the image GK41 of the key K69 when the pointer is out of the key range of the key K69. It is to be noted that the image GK42 has the same size as the image GK12 shown in FIG. 6.

In this embodiment, as shown in FIG. 14, the image GK42 of the key includes regions. The number and an arrangement of the regions correspond one-to-one to the number and arrangement of the selection buttons Bs1 to Bs5 of the remote control 10.

One input item is assigned to each of the regions. For example, the key K69 is associated with the input items “9,” “W,” “X,” “Y,” and “Z” which correspond to the selection buttons Bs1 to Bs5. It is to be noted that since there are no selection buttons corresponding to the top-left, bottom-left, top-right, and bottom-right regions, nothing is assigned to these regions.

### [2-3. Modification]

Although this embodiment describes the case where the number of the selection buttons is five using the remote control 10B shown in FIG. 10A as the example, the present invention is not limited to this. For instance, a remote control 10C shown in FIG. 10B may be used. The remote control 10C differs from the remote control 10B in selection button shape. Specifically, selection buttons Bs1, 2, 4, and 5 are integrally provided in a ring shape, and a circular button Bs2 is provided at the center. Since the remote control 10C has the same number and arrangement of the selection buttons as the remote control 10B, the remote control 10C is capable of using the same software keyboard SK3 used by the remote control 10B.

### [2-4. Effects]

As with Embodiment 1, the information processing device (STB 30) according to this embodiment performs the object selection (key selection) by using the angle of the remote control 10 in combination with the input item specification through the button operation on the remote control 10. Thus, as with Embodiment 1, the information processing device according to this embodiment makes it possible to reduce the number of wrong inputs caused by hand movement without increasing the number of the button operations.

Moreover, as with Embodiment 1, with the information processing device according to this embodiment, since the image GK32 and the image GK42 of the keys displayed when the pointer P is within the key ranges correspond to the number and arrangement of the selection buttons Bs1 to Bs5 of the remote control 10, the user can easily understand the correspondence relationship between the selection buttons and the characters to be input.

Furthermore, as with Embodiment 1, with the information processing device according to this embodiment, since the image GK32 and the image GK42 of the keys displayed when the pointer P is within the key ranges are larger than the image GK31 and the image GK41 of the keys displayed when the pointer P is out of the key ranges, it is possible to reduce the number of the wrong inputs caused by the hand movement.

### Embodiment 3

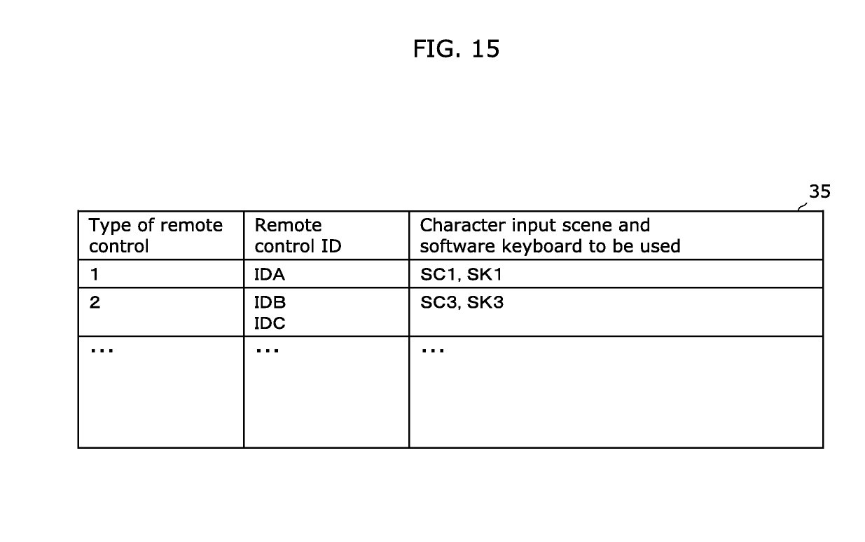

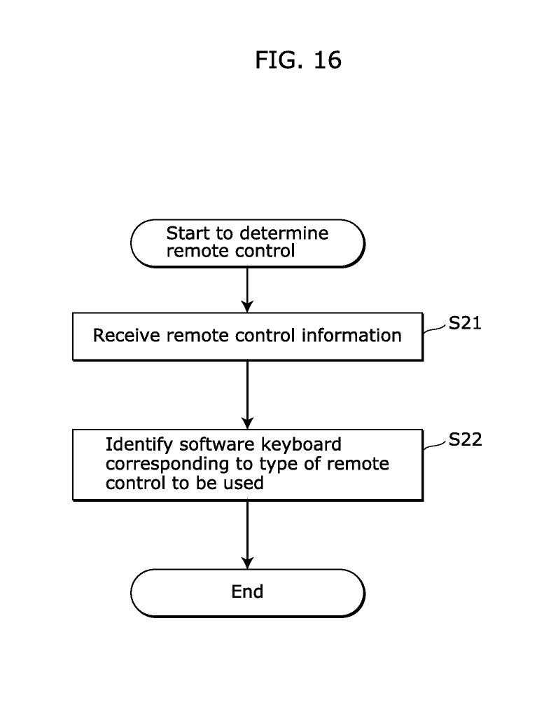

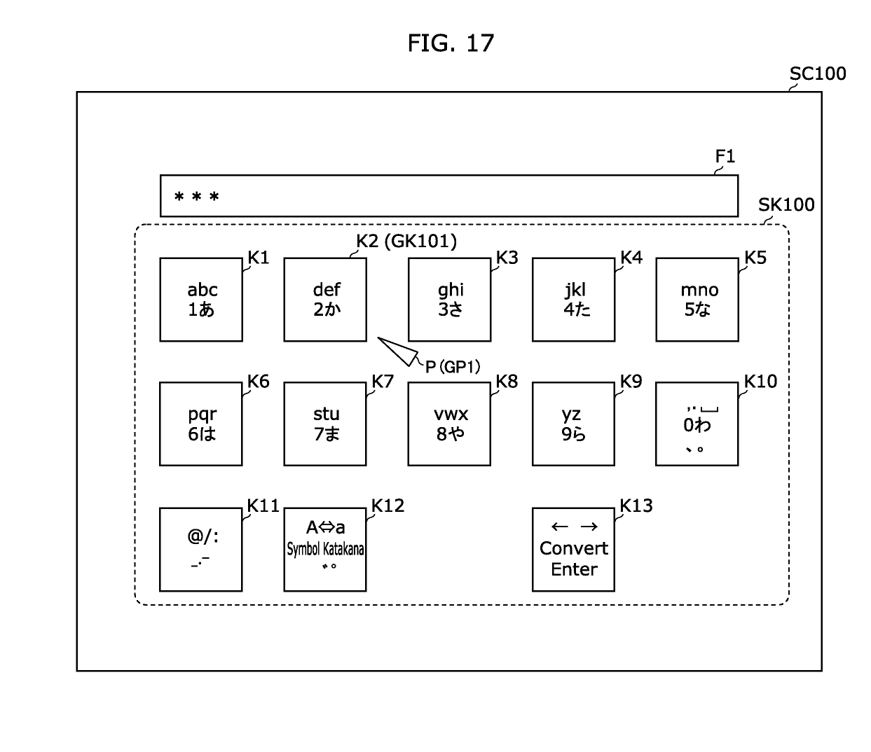

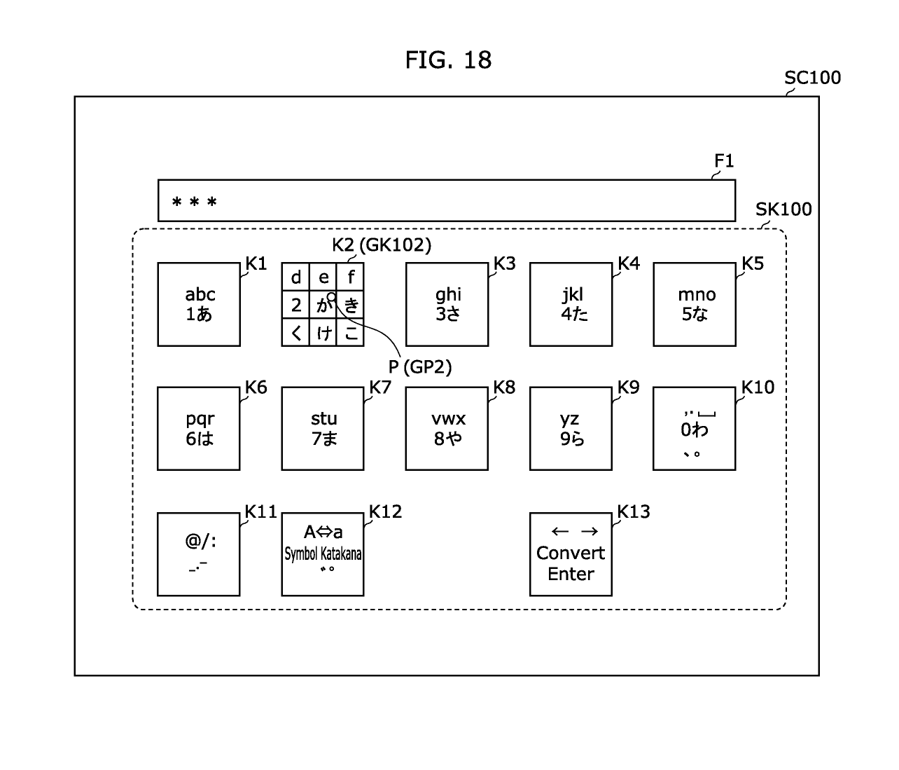

An information processing device, a method for operating an information processing device, and an information processing system according to Embodiment 3 are described below based on FIG. 15 and FIG. 16.

In this embodiment, a case is described where remote controls 10 having different arrangements, numbers, shapes, and the like of buttons can be used.

As with the information processing system 1 according to Embodiment 1 shown in FIG. 1, the information processing system according to this embodiment includes a remote control 10, a liquid crystal display 20 having a display screen, and an STB 30 that is an exemplary information processing device. It is to be noted that the liquid crystal display 20 is the same as those in Embodiment 1 and Embodiment 2.

### [3-1. Configuration of Remote Control 10]

The following describes a configuration of the remote control 10 according to this embodiment.

As with the remote control 10 according to Embodiment 1 shown in FIG. 2, the remote control 10 according to this embodiment includes buttons, an angular velocity measuring unit 11, a button input detecting circuit 12, a button information generating circuit 13, and a transmitting unit 14.

It is to be noted that the buttons, the angular velocity measuring unit 11, the button input detecting circuit 12, and the button information generating circuit 13 are the same as those in Embodiment 1 or Embodiment 2.

The transmitting unit 14 is an interface for wirelessly communicating with the STB 30, and transmits, for example, angular velocity information and button information. When a power button Bp1 of the remote control 10 is pressed, the transmitting unit 14 according to this embodiment transmits remote control information indicating a type of remote control, together with button information indicating that the power button Bp1 has been pressed. Moreover, when a button of the remote control 10 indicating a remote control to be used is switched is pressed, the transmitting unit 14 according to this embodiment transmits the remote control information. The remote control information is a remote control ID, for example.

### [3-2. Configuration of STB 30]

A configuration of the STB 30 is described below based on FIG. 15 and FIG. 16. FIG. 15 is an exemplary table used in this embodiment, and FIG. 16 is a flow chart showing operation of a display control unit 32 according to this embodiment.

As with the STB 30 according to Embodiment 1 shown in FIG. 3, the STB 30 according to this embodiment includes an operation information obtaining unit 31, a display control unit 32, an input item receiving unit 33, and a storage unit 34. It is to be noted that the input item receiving unit 33 is the same as those in Embodiment 1 and Embodiment 2.

The operation information obtaining unit 31 receives angular velocity information and button information from the remote control 10 through wireless communication. The operation information obtaining unit 31 according to this embodiment further receives remote control information.

As with Embodiment 1 and Embodiment 2, the storage unit 34 includes a given storage circuit such as a RAM and a ROM. As with Embodiment 1 and Embodiment 2, the storage unit 34 stores a computer program. Moreover, the storage unit 34 according to this embodiment stores, for each of types of remote control, an image of a character input scene, an image of a pointer, an image of a software keyboard, and so on. Furthermore, the storage unit 34 according to this embodiment stores a table 35 for identifying, for each type of remote control, a remote control ID and images of a character input scene and a software keyboard to be used.

In the table 35, IDA, a remote control ID, corresponds to the remote control 10A (FIG. 1) according to Embodiment 1, for instance. Moreover, for example, IDB and IDC, remote control IDs, correspond to the remote controls 10B (FIG. 10A) and 10C (FIG. 10B) according to Embodiment 2, respectively. As shown in FIG. 15, one or more remote control IDs may be assigned to one type of remote control in the table 35. For instance, the remote control 10B and the remote control 10C according to Embodiment 2 may be of the same type. It is to be noted that a type of remote control may correspond one-to-one to a character input scene and a software keyboard to be used

In this embodiment, if the operation information obtaining unit 31 receives remote control information (step S21 in FIG. 16), the display control unit 32 determines a type of the remote control 10 using the table 35 stored in the storage unit 34 (step S22 in FIG. 16). The display control unit 32 searches the table for a record including a remote control ID indicated by the remote control information, and identifies a character input scene and a software keyboard to be used, based on the record.

As with Embodiment 1 and Embodiment 2, the display control unit 32 displays the character input scene on the display screen of the liquid crystal display 20, and controls display of the character input scene and a pointer based on operation information from the remote control 10 (S10 to S20 in FIG. 4). Here, the displayed character input scene is a character input scene identified in step S22.

### [3-3. Effects]

The information processing device (STB 30) according to this embodiment is useful in an environment where types of the remote controls 10 are used. Since the information processing device corresponds to the types of the remote controls 10, it is possible to increase the versatility of the information processing device.

Moreover, as with Embodiment 1 and Embodiment 2, the information processing device (STB 30) according to this embodiment performs the object selection (key selection) by using the angle of the remote control 10 in combination with the input item specification through the button operation on the remote control 10. Thus, as with Embodiment 1 and Embodiment 2, the information processing device according to this embodiment makes it possible to reduce the number of wrong inputs caused by hand movement without increasing the number of the button operations.

Furthermore, as with Embodiment 1 and Embodiment 2, with the information processing device according to this embodiment, since the image of the key displayed when the pointer P is within the key range corresponds to the number and arrangement of the selection buttons of the remote control 10, the user can easily understand the correspondence relationship between the selection buttons and the characters to be input.

Moreover, as with Embodiment 1 and Embodiment 2, with the information processing device according to this embodiment, since the image of the key displayed when the pointer P is within the key range is larger than the image of the key displayed when the pointer P is out of the key range, it is possible to reduce the number of the wrong inputs caused by the hand movement.

### Embodiment 4

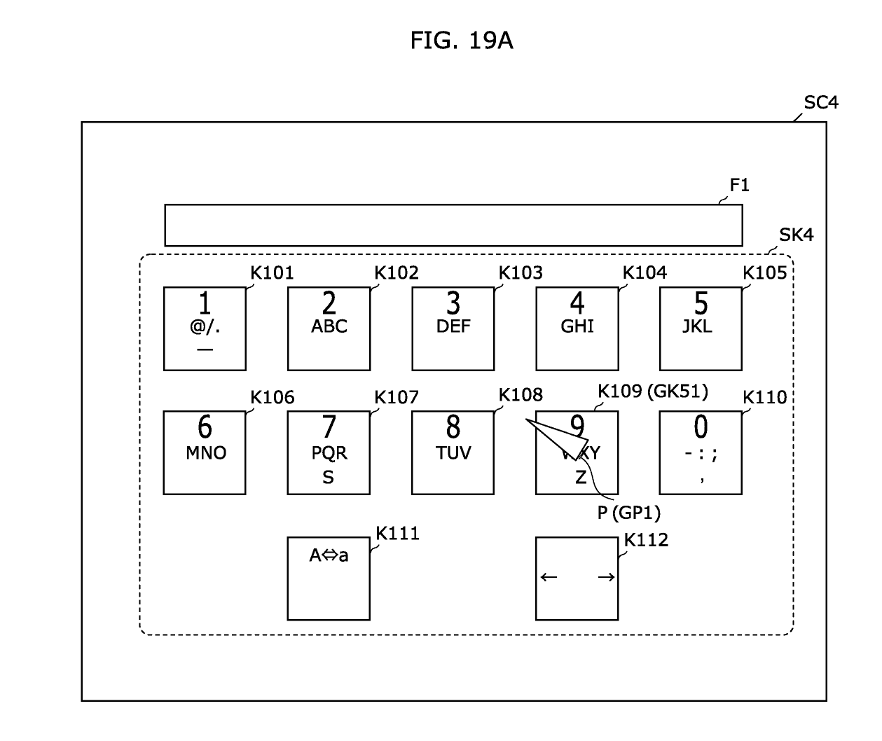

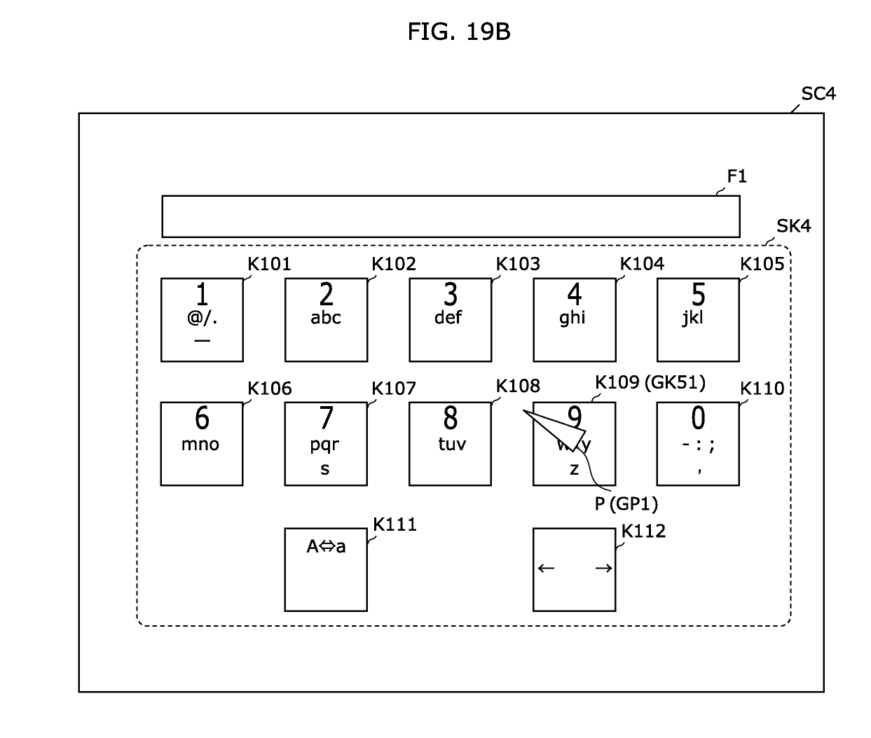

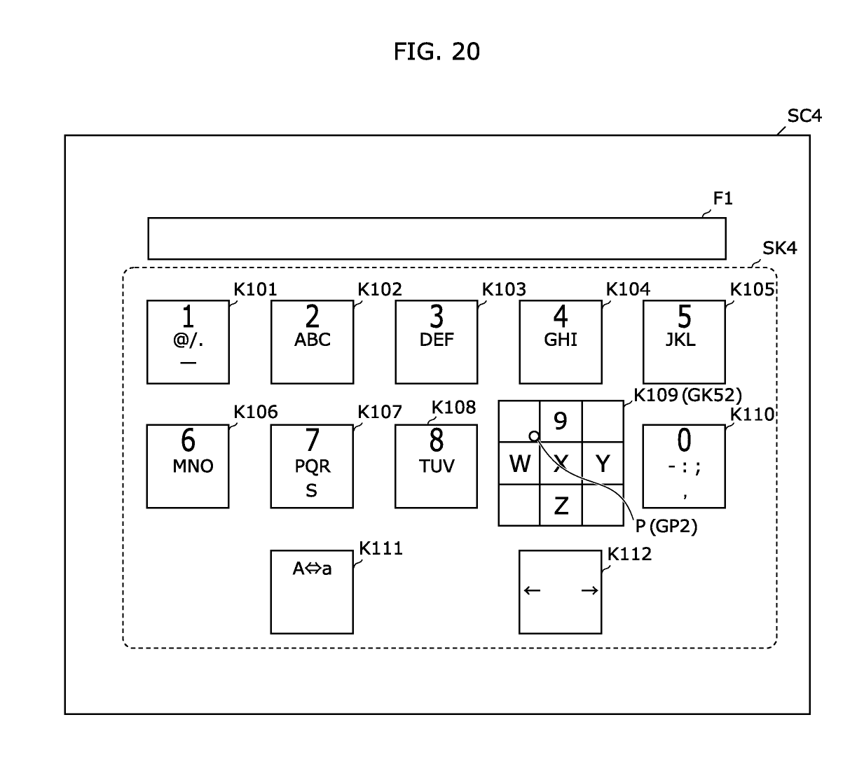

An information processing device, a method for operating an information processing device, and an information processing system according to Embodiment 4 are described below based on FIG. 19A to FIG. 20.

As with the information processing system 1 according to Embodiment 1 shown in FIG. 1, the information processing system according to this embodiment includes a remote control 10, a liquid crystal display 20 having a display screen, and an STB 30 that is an exemplary information processing device. It is to be noted that the remote control 10 and the liquid crystal display 20 are the same as those in Embodiment 1. Moreover, the STB 30 has the same configuration and operates in the same manner as the one in Embodiment 1 except elements of a character input scene to be displayed.

### [4-1. Character Input Scene]

Elements of a character input scene in this embodiment are described below based on FIG. 19A to FIG. 20.

It is to be noted that as with Embodiment 1, the elements of the character input scene differ between a case where a pointer P is out of a key range and a case where the pointer P is within the key range.

First, the character input scene when the pointer P is out of a key range is described below based on FIG. 19A and FIG. 19B. FIG. 19A and FIG. 19B each are a diagram showing an exemplary character input scene when the pointer P is out of the key range.

The character input scene SC4 shown in each of FIG. 19A and FIG. 19B shows a character input field F1, a software keyboard SK4, and the pointer P. FIG. 19A shows a character input scene for inputting a large English alphabet and a symbol, and FIG. 19B shows a character input scene for inputting a small English alphabet and a symbol. If a key K111 is selected when the character input scene shown in FIG. 19A is displayed on the liquid crystal display 20, the character input scene shown in FIG. 19B is displayed on the liquid crystal display 20. Conversely, if the key K111 is selected when the character input scene shown in FIG. 19B is displayed on the liquid crystal display 20, the character input scene shown in FIG. 19A is displayed on the liquid crystal display 20.

As with Embodiment 1, the character input field F1 is a region showing a character specified through an operation on the remote control 10. The character input field F1 shows a cursor indicating a position at which a character is input, in addition to the character specified through the operation on the remote control 10.

The software keyboard SK4 is displayed on the display screen, and includes keys K101 to K112 (corresponding to exemplary objects). A user inputs a character by operating the remote control 10 to designate, with the pointer P, a key associated with the character the user wants to input.

In the character input scene SC4, a size and an arrangement of the keys K101 to K112 are set according to the operability of the remote control 10.

Here, as described in Embodiment 1, if the operability of the remote control 10 is considered, the maximum number of keys that can be arranged in a row is seven. In the character input scene SC4 shown in each of FIG. 19A and FIG. 19B, each key is designed to have a width corresponding to an angle of 6 degrees of the remote control 10, and a maximum of five keys are arranged in a row. Moreover, to reduce erroneous determination of a position of the pointer P, a space corresponding to an angle of 3 degrees is provided between adjacent keys. Specifically, in the character input scene SC4 shown in each of FIG. 19A and FIG. 19B, the keys K101 to K105, the keys K106 to K110, and the keys K111 and K112 are arranged in the first row, the second row, and the third row from the top, respectively.

As with Embodiment 1, each of the keys K101 to K112 corresponds to different input items. In this embodiment, the input items include a character such as an English alphabet, a numeral, and a symbol, and functions such as switch of a character type and a cursor movement.

More specifically, the keys K101 and K110 each correspond to one numeral and four symbols, the keys K102 to K109 each correspond to one numeral and four English alphabets, the key K111 corresponds to conversion of a character type (conversion from a large character to a small character and vice versa), and the key K112 corresponds to a cursor movement (rightward movement and leftward movement).

Each of images GK51 of the keys K101 to K112 includes one region and shows characters (figure) representing the associated characters. For instance, in the case of FIG. 19A, the image GK51 of the key K101 shows “1@/.-,” and the image GK51 of the key K102 shows “2ABC.” In the case of FIG. 19B, the image GK51 of the key K101 shows “1@/.-,” and the image GK51 of the key K102 shows “2abc.” The whole images of the respective keys K101 to K112 are key ranges.

As with Embodiment 1, the pointer P indicates a position, which is indicated by the remote control 10, on the display screen of the liquid crystal display 20. If the pointer P is out of a key range, the pointer P is represented by an isosceles triangle arrow image GP1 as shown in FIG. 19A to FIG. 20. The tip of the arrow corresponds to a position (coordinates) of the pointer P.

Next, a character input scene when the pointer P is within a key range is described below based on FIG. 20. FIG. 20 shows a case where the pointer P is within a key range of the key K109. It is to be noted that although FIG. 20 shows the case where the pointer P is within the key range when the character input scene SC4 shown in FIG. 19A is displayed, the same processing is performed also for the case of FIG. 19B.

The character input scene SC4 shown in FIG. 20 shows the character input field F1, the software keyboard SK4, and the pointer P.

The character input field F1 is the same as the one shown in FIG. 19A.

The software keyboard SK4 differs from the one shown in FIG. 19A only in the key K109 on which the pointer P is. In FIG. 20, an image of the key K109 when the pointer P is within the key range of the key K109 is an image GK52.

As with Embodiment 1, the image GK52 is larger than the image GK51. As with Embodiment 1, the image GK52 is designed to have the maximum size in a state where the arrangement of the keys K101 to K108 and K110 to K112 is not changed and a space necessary for reducing erroneous determination of a position of the pointer P is maintained between the key K109 and the adjacent keys K104, K108, K110, and K112. Specifically, in the character input scene SC4 shown in FIG. 20, the image GK52 of the key K109 is designed to correspond in size to an angle of 9 degrees of the remote control 10.

As shown in FIG. 20, the image GK52 of the key K109 includes regions. The number and an arrangement of the regions correspond one-to-one to the number and arrangement of the selection buttons Bs1 to Bs9 of the remote control 10. In this embodiment, since the remote control 10 includes the nine selection buttons Bs1 to Bs9, the image GK52 includes the nine regions. Moreover, since the nine selection buttons Bs1 to Bs9 are arranged in a 3×3 matrix, the image GK52 includes nine equal-size rectangles that are arranged in the 3×3 matrix. In other words, the image GK52 is obtained by dividing one rectangle by 3 rows and 3 columns. Since the image GK52 is designed to have a width corresponding to the angle of 9 degrees of the remote control 10, a width of each of the regions corresponds to an angle of 9/3=3 degrees of the remote control 10.

One input item is assigned to each of the regions. For example, the key K109 is associated with the input items “9,” “W,” “X,” “Y,” and “Z.” “9” is assigned to the top-middle region corresponding to the selection button Bs2. “W” is assigned to the left-middle region corresponding to the selection button Bs4. “X” is assigned to the middle region corresponding to the selection button Bs5. “Y” is assigned to the right-middle region corresponding to the selection button Bs6. “Z” is assigned to the bottom-middle region corresponding to the selection button Bs8. In this embodiment, no character is assigned to the selection buttons Bs1, Bs3, Bs7, and Bs9. It is to be noted that if the pointer P is within a key range of any one of the keys K101 to K108 and K110 to K112, an image corresponding to the image GK52 of the key K109 is displayed.

It is to be noted that the whole image (including all of the nine regions) of the key K109 is a key range.

As with Embodiment 1, if the pointer P is within any key range, the pointer P is represented by a circular dot image GP2 shown in FIG. 20. Changing the image of the pointer P to the dot image GP2 smaller than the arrow image GP1 allows the user to more easily view the image of the key on which the pointer P is.

### [4-2. Operation of STB 30]

An operation of the STB 30 is described below based on FIG. 4 and FIG. 19A to FIG. 20.

When a character input interface (I/F) is started, the display control unit 32 of the STB 30 displays a character input scene on the display screen of the liquid crystal display 20 (S10).

In step S10, the display control unit 32 displays, on the display screen of the liquid crystal display 20, the character input scene SC4 shown in FIG. 19A. At this time, the pointer P has an arrow shape (isosceles triangle shape).

Moreover, the display control unit 32 sets, for each of the keys K101 to K112, a key range indicating a range for determining that the pointer P is on a key. As with Embodiment 1, the key ranges are the same as a range displaying the image GK51 of a key. In step S10, the same range as the range of the image GK51 is set as the key ranges for all the keys K101 to K112.

After displaying the character input scene SC4 shown in FIG. 19A, the STB 30 determines whether there is a request to end character input (S11).

If the STB 30 determines that the request to end the character input is present in step S11 (“Yes” in S11), the STB 30 ends the display of the character input scene SC4 (S20) and terminates the character input I/F.

If the STB 30 determines that there is no request to end the character input in step S11 (“No” in S11), the STB 30 determines a position of the pointer P (S12). In this step, since the first determination of the position of the pointer P or the last determination of the position of the pointer P shows that the pointer P is out of a key range, the STB 30 performs the determination for the keys K101 to K112 using the respective key ranges corresponding in size to the images GK51.

If the pointer P is out of any key range (“Out of key range” in S12), the STB 30 returns to step S11.

If the pointer P is within any key range (“Within key range” in S12), the display control unit 32 of the STB 30 changes display of the pointer P and one of the keys which corresponds to the key range, to change the key range (S13). Hereinafter, a case is described where the pointer P is within the key range of the key K109.

Specifically, the display control unit 32 changes the image of the pointer P from the arrow image GP1 shown in FIG. 19A to the circular dot image GP2 shown in FIG. 20.

Moreover, the display control unit 32 changes the image of the key on which the pointer P is from the image GK51 shown in FIG. 19A to the image GK52 shown in FIG. 20.

Furthermore, the display control unit 32 changes the key range of the key on which the pointer P is from the range of the image GK51 to the range (range including all of the nine regions) of the image GK52. Since the image GK52 is larger than the image GK51, if the pointer P is within the key range, the key range increases in size.

After displaying the character input scene SC4 shown in FIG. 20, the STB 30 determines whether there is a request to end character input (S14).

If the STB 30 determines that the request to end the character input is present in step S14 (“Yes” in S14), the STB 30 changes the character input scene SC4 shown in FIG. 20 to the character input scene SC4 shown in FIG. 19A (S19), ends the display of the character input scene SC4 (S20), and terminates the character input I/F. It is to be noted that the STB 30 may end the display of the character input scene SC4 shown in FIG. 20 without returning it to the character input scene SC4 shown in FIG. 19A.

If the STB determines that there is no request to end the character input in step S14 (“No” in S14), the STB 30 determines whether button information indicating a pressed button is present (S15).

If the STB 30 determines that the button information is present (“Yes” in S15), that is, if the STB receives a selection button operation, the STB 30 performs an operation according to the button information (S16). For instance, if the button information is information indicating any one of the selection buttons Bs2, Bs4 to Bs6, and Bs8 has been pressed, the input item receiving unit 33 of the STB 30 specifies a character corresponding to the pressed selection button and displays the character in the character input field F1. For example, if the selection button Bs2 is pressed when the pointer P is within the key range of the key K109 as shown in FIG. 20, the display control unit 32 specifies “9” at the corresponding position and displays “9” in the character input field F1. Likewise, if any one of the selection buttons Bs4 to Bs6 and Bs8 is pressed, the display control unit 32 specifies a corresponding one of “W,” “X,” “Y,” and “Z” at the corresponding positions and displays the corresponding one of “W,” “X,” “Y,” and “Z” in the character input field F1.

After determining whether button information is present (S15) and performing an operation according to the button information (S16), the STB 30 determines a position of the pointer P (S17). Here, for instance, since the last determination shows that the pointer P is within the key range of the key K109, the STB 30 performs the determination for the key K109 using the key range corresponding in size to the image GK52. Moreover, the STB 30 performs the determination for the keys K101 to K108 and K110 to K112 using the respective key ranges corresponding in size to the image GK51.

If the pointer P is within the key range (“Within key range” in S17), the STB 30 returns to step S14. If the selection buttons Bs2, Bs4 to Bs6, and Bs8 are continuously pressed without moving the pointer P, configuring the STB 30 as steps S14 to S17 enables continuous input of the characters corresponding to the pressed selection buttons. In other words, only the simple operation, the continuous operation of the selection buttons Bs2, Bs4 to Bs6, and Bs8, enables the continuous input of the characters.

If the pointer P is out of the key range (“Out of key range” in S17), the display control unit 32 of the STB 30 changes a scene on the display screen of the liquid crystal display 20 from the character input scene SC4 shown in FIG. 20 to the character input scene SC4 shown in FIG. 19A, and the STB 30 returns to step S11 (S18).

More specifically, the display control unit 32 changes the image of the pointer P from the circular dot image GP2 shown in FIG. 20 to the arrow image GP1 shown in FIG. 19A. Moreover, the display control unit 32 changes the image of the key K109 from the image GK52 shown in FIG. 20 to the image GK51 shown in FIG. 19A.

Furthermore, the display control unit 32 changes the key range from the range of the image GK52 to the range of the image GK51.

### [4-3. Modification]

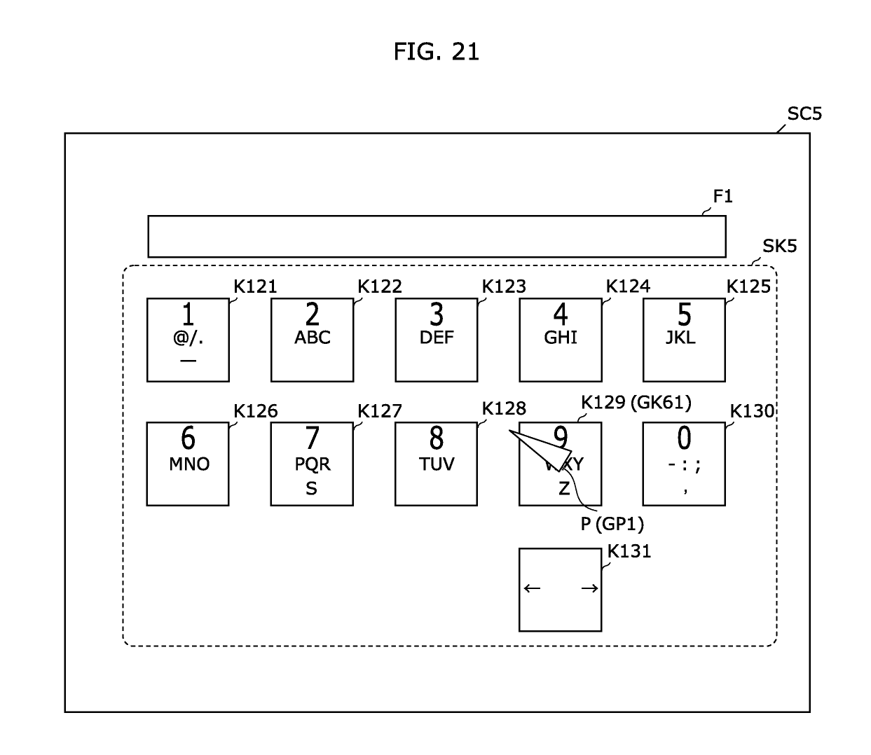

The following describes a modification of Embodiment 4 based on FIG. 21 to FIG. 23.

This modification describes a character input scene, particularly a configuration of the software keyboard, which is different from Embodiment 4.

First, a character input scene when a pointer P is out of a key range is described below based on FIG. 21. FIG. 21 is a diagram showing an exemplary character input scene SC5 in this modification.

The character input scene SC5 shown in FIG. 21 shows a character input field F1, a software keyboard SK5, and the pointer P.

Display of the character input field F1 and the pointer P is the same as in Embodiment 1.

The software keyboard SK5 includes keys K121 to K131 (corresponding to exemplary objects).

In the character input scene SC5, a size and an arrangement of the keys are set according to the operability of the remote control 10 in the same manner as the character input scene SC4. More specifically, the number of keys arranged in one row is five, and a width of each of the keys and an interval between the keys are the same as those in the character input scene SC4. In the character input scene SC5 shown in FIG. 21, the keys K121 to K125, the keys K126 to K130, and the key K131 are arranged in the first row, the second row, and the third row from the top, respectively.

The keys K121 and K130 each correspond to one numeral and four symbols, the keys K122 to K129 each correspond to one numeral and four English alphabets, and the key K131 corresponds to a cursor movement (rightward movement and leftward movement).

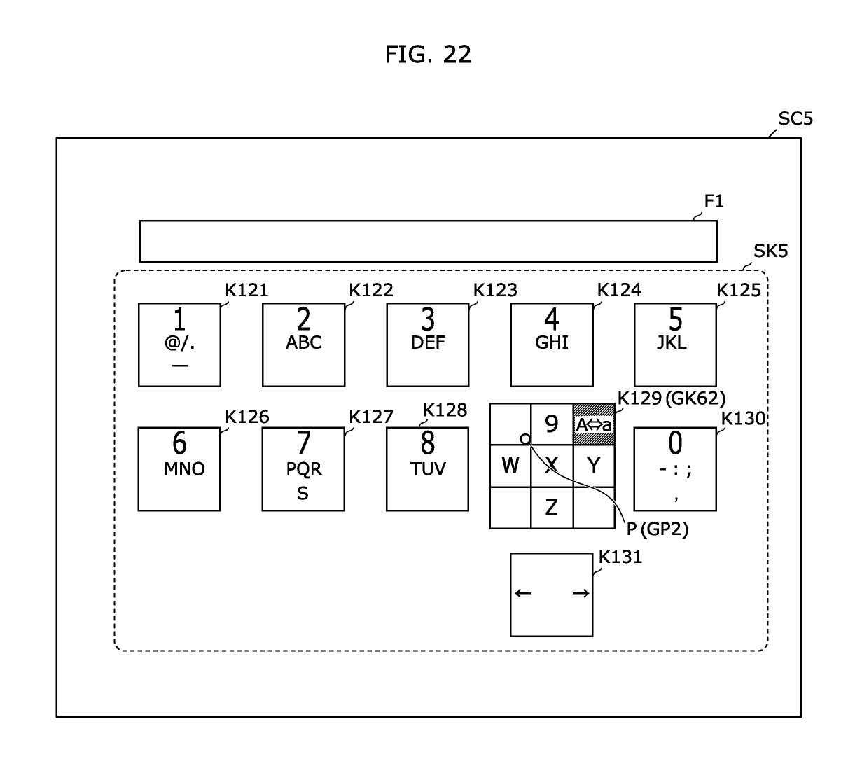

Next, a character input scene when the pointer P is within a key range is described below based on FIG. 22. FIG. 22 is a diagram showing an exemplary character input scene SC5 in this modification. FIG. 22 shows a case where the pointer P is within a key range of the key K129.

The character input scene SC5 shown in FIG. 22 shows the character input field F1, the software keyboard SK5, and the pointer P.

Display of the character input field F1 and the pointer P is the same as in Embodiment 4.

If the pointer P moves into the key range of the key K129, the display control unit 32 changes an image of the key K129 from an image GK61 shown in FIG. 21 to an image GK62 shown in FIG. 22.

The image GK62 of the key K129 when the pointer P is within the key range of the key K129 is larger than the image GK61 of the key K129 when the pointer is out of the key range of the key K129. It is to be noted that the image GK62 has the same size as the image GK52 shown in FIG. 20.

In this modification, as shown in FIG. 22, the image GK62 of the key 129 includes regions. The number and an arrangement of the regions correspond one-to-one to the number and arrangement of the selection buttons Bs1 to Bs9 of the remote control 10 in the same manner as in Embodiment 1.

One input item is assigned to each of the regions. For instance, the key K129 is associated with input items such as “9,” a switch from large character to small character or from small character to large character, and “W,” “X,” “Y,” and “Z” which correspond to the selection buttons Bs2 to Bs6 and Bs8. In this modification, no character is assigned to the selection buttons Bs1, Bs7, and Bs9.

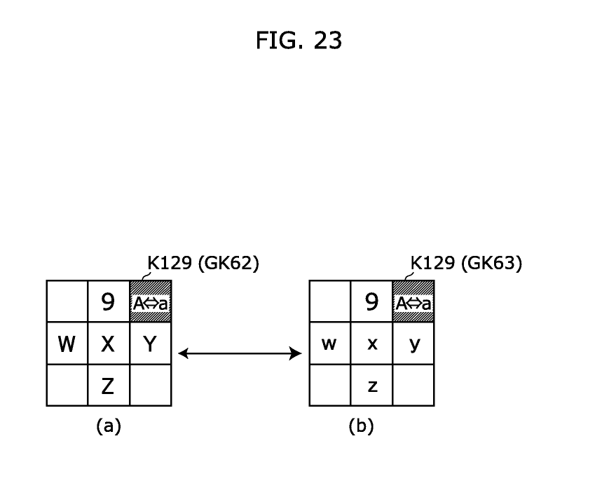

FIG. 23 is a diagram showing an exemplary transition of an image of a key when the pointer P is within a key range.

(a) of FIG. 23 is the same as the image GK62 of the key K129. (b) of FIG. 23 shows an exemplary image GK63 of the key K129 when input of a small character is selected.

The image GK62 shown in (a) of FIG. 23 shows the numeral “9,” conversion of character type, and the large characters “W,” “X,” “Y,” and “Z.” The image GK63 shown in (b) of FIG. 23 shows the numeral “9,” conversion of character type, and the small characters “w,” “x,” “y,” and “z.”

The following describes a method for switching between images of a key in the character input scene SC5, which is performed by the display control unit 32.

When the pointer P moves into the key range of the key K129 when the character input scene SC5 shown in FIG. 21 is displayed, as shown in FIG. 22, the display control unit 32 switches the image of the key K129 from the image GK61 shown in FIG. 21 to the image GK62 ((a) of FIG. 23) shown in FIG. 22.

If the selection button Bs3 is pressed in a state where the image GK62 shown in (a) of FIG. 23 is displayed, since the selection button Bs3 corresponds to the region to which the switch to small character is assigned, the display control unit 32 switches the image of the key K129 to the image GK63 shown in (b) of FIG. 23.

If the selection button Bs3 is pressed in a state where the image GK63 shown in (b) of FIG. 23 is displayed, since the selection button Bs3 corresponds to the region to which the switch to large character is assigned, the display control unit 32 switches the image of the key K129 to the image GK62 shown in (a) of FIG. 23.

If any of the selection buttons Bs2, Bs4 to Bs6, and Bs8 is pressed in a state where one of (a) and (b) of FIG. 23 is displayed, the input item receiving unit 33 displays the corresponding character at a cursor position in the character input field F1.

### [4-4. Effects]

As with Embodiment 1, the information processing device (STB 30) according to this embodiment performs the object selection (key selection) by using the angle of the remote control 10 in combination with the input item specification through the button operation on the remote control 10. For this reason, with the information processing device according to this embodiment, bringing the pointer P onto the relatively small region such as “d” and “e” is not required, and the pointer P may be brought onto the image GK52 of the relatively large key. In other words, with the information processing device according to this embodiment, the range of the region onto which the pointer P is brought is wide, and thus it is possible to reduce the number of wrong inputs caused by hand movement.

Moreover, since the character specification is performed through the button operation on the remote control 10, it is possible to suppress an increase in the number of button operations. In particular, if characters associated with the same object (key) are continuously input, it is possible to expect a reduction in the number of button operations.

Furthermore, with the information processing device according to this embodiment, since the image GK52 of the key displayed when the pointer P is within the key range corresponds to the number and arrangement of the selection buttons Bs1 to Bs9 of the remote control 10, the user can easily understand the correspondence relationship between the selection buttons and the characters to be input.

Moreover, with the information processing device according to this embodiment, since the image GK52 of the key displayed when the pointer P is within the key range is larger than the image GK51 of the key displayed when the pointer P is out of the key range, it is possible to reduce the number of the wrong inputs caused by the hand movement.

### Other Embodiments

Although the information processing device, the method for operating an information processing device, and the information processing system according to the embodiments of the present invention have been described above, the present invention is not limited to these embodiments.

(1) Although Embodiments 1 to 4 have described the case where the character input is performed with the software keyboard, the present invention is not limited to the case. For instance, the present invention can be applied to a case where a menu is selected from menus in a menu selection scene presenting the menus.

Specifically, for instance, if the information processing device has a function to reproduce recorded content, functions such as forward, pause, play, rewind, and stop are assigned to the respective selection buttons of the remote control 10, and an object showing the functions is displayed at a corner of the display screen of the liquid crystal display 20. Such a configuration eliminates the need for assigning a dedicated button to a function such as fast-forward. Moreover, with the information processing device according to the embodiments, the size of the objet can be reduced considerably, and thus it is possible to more effectively prevent an obstruction to viewing of the content.

(2) Although Embodiments 1 to 4 have described the case where the storage unit 34 included in the STB 30 stores the character input scene or the like, the present invention is not limited to this. If the STB 30 is connected to a network such as the Internet, a character input scene or the like may be previously stored in a storage device on the network, and information such as the character input scene may be obtained from the storage device.

(3) Although Embodiments 1 to 4 have described the case where the image of the key displayed when the pointer P is within the key range is larger than the image of the key displayed when the pointer P is out of the key range, the present invention is not limited to this. The image of the key displayed when the pointer P is within the key range may have the same size as the image of the key displayed when the pointer P is out of the key range.

(4) Although Embodiments 1 to 4 have described, as an example, the case where the information processing device is the STB 30 capable of using ANDROID (registered trademark), the present invention is not limited to this. The present invention may be applied to a game console, an AV apparatus, or the like.

(5) Although Embodiment 1 has described the case where all the selection buttons Bs1 to Bs9 of the remote control 10A are used, the present invention is not limited to this. The software keyboard SK3 may be used only with, among the selection buttons Bs1 to Bs9 of the remote control 10A, the selection buttons Bs2, Bs4 to Bs6, and Bs8 (corresponding to the selection buttons Bs1 to Bs5 of the remote controls 10B and 10C).

(6) Although Embodiments 1 and 2 have respectively described the case where the remote control 10A includes the nine selection buttons and the case where the remote control 10B includes the five selection buttons, the number of the selection buttons of the remote control 10 is arbitrary. Keys of a software keyboard may correspond to the number and arrangement of the selection buttons.

(5) Although Embodiments 1 to 4 have described the case where the regions of the key on which the pointer P is correspond one-to-one to the selection buttons, the present invention is not limited to this. The selection buttons may be associated with one region.

(8) Moreover, the respective units described above (the operation information obtaining unit 31, the display control unit 32, the input item receiving unit 33, and the storage unit 34) may be specifically configured as a computer system made up of a microprocessor, a ROM, a RAM, a hard disk drive, a display unit, a keyboard, a mouse, and so on. A computer program is stored in the RAM or the hard disk drive. The respective units achieve their functions by way of the microprocessor operating according to the computer program. Here, the computer program is configured of a combination of command codes indicating commands to the computer in order to achieve a predetermined function.

Furthermore, some or all of the structural elements included in each of the above-described units may be realized as a single system Large Scale Integration (LSI). The system LSI is a super multifunctional LSI manufactured by integrating a plurality of components onto a signal chip. More specifically, the system LSI is a computer system configured with a microprocessor, a ROM, a RAM, and so forth. The RAM stores a computer program. The microprocessor operates according to the computer program, so that a function of the system LSI is carried out.

Moreover, some or all of the structural elements included in each of the above-described units may be implemented as an IC card or a standalone module that can be inserted into and removed from the corresponding device. The IC card or the module is a computer system configured with a microprocessor, a ROM, a RAM, and so forth. The IC card or the module may include the aforementioned super multifunctional LSI. The microprocessor operates according to the computer program, so that a function of the IC card or the module is carried out. The IC card or the module may be tamper resistant.

Furthermore, the present invention may be the methods described above. Also, the present invention may be a computer program for implementing such methods using a computer, or may be a digital signal of the computer program.

Moreover, the present invention may be the aforementioned computer program or digital signal recorded on a non-transitory computer-readable recording medium, such as a flexible disk, a hard disk, a CD-ROM, an MO, a DVD, a DVD-ROM, a DVD-RAM, a Blu-ray Disc (BD) (registered trademark), or a semiconductor memory. Also, the present invention may be the digital signal recorded on such non-transitory recording mediums.

Furthermore, the present invention may be the aforementioned computer program or digital signal transmitted via a telecommunication line, a wireless or wired communication line, a network represented by the Internet, and data broadcasting.

Moreover, the present invention may be a computer system including a microprocessor and a memory. The memory may store the aforementioned computer program, and the microprocessor may operate according to the computer program.

Furthermore, by transferring the non-transitory recording medium having the aforementioned program or digital signal recorded thereon or by transferring the aforementioned program or digital signal via the aforementioned network or the like, the present invention may be implemented by a different independent computer system.

In addition, the above-described exemplary embodiments and the above-described modification may be combined with each other.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to a device that enables character input on a display screen with a remote control including an angular velocity measuring unit and selection buttons, such as an STB, a game console, and an AV apparatus.

1. An information processing device that receives (i) a selection button operation corresponding to a press of one of selection buttons of a remote control and (ii) a cursor operation corresponding to a tilt of a case of the remote control, the information processing device comprising:
a display control unit configured to display a pointer on a display screen according to the cursor operation and display, if the pointer is on an object displayed on the display screen, a plurality of input items assigned to the object; and
an input item receiving unit configured to receive one of the input items displayed by the display control unit, according to the selection button operation.

2. The information processing device according to claim 1,
wherein the display control unit is configured to display, as the object, an image including a plurality of regions each corresponding to a different one of the input items.

3. The information processing device according to claim 2,
wherein the display control unit is configured to display, as the object, the image including the regions, when the pointer is on the object, and display, as the object, an image added with patterns representing the input items, when the pointer is off the object.

4. The information processing device according to claim 1,
wherein each of the input items is assigned to a different one of the selection buttons.

5. The information processing device according to claim 4,
wherein the number and an arrangement of the input items of the object are the same as the number and an arrangement of the selection buttons of the remote control.

6. The information processing device according to claim 1,
wherein the object is larger when the pointer is on the object than when the pointer is not on the object.

7. The information processing device according to claim 1,
wherein the pointer is smaller when the pointer is on the object than when the pointer is not on the object.

8. The information processing device according to claim 1,
wherein if the information processing device continuously receives a plurality of the selection button operations while the pointer is continuously on the object, the input item receiving unit is configured to receive, among the input items, input items each corresponding to one of the received selection button operations.

9. The information processing device according to claim 1, further comprising
a storage unit configured to store the object that is set for each of types of a plurality of the remote controls,
wherein if the display control unit further receives, from the remote control, remote control information identifying a type of the remote control, the display control unit is configured to display the object according to the remote control information.

10. A method for operating an information processing device that receives (i) a selection button operation corresponding to a press of one of selection buttons of a remote control and (ii) a cursor operation corresponding to a tilt of a case of the remote control, the method comprising:
displaying a pointer on a display screen according to the cursor operation;
displaying, if the pointer is on an object displayed on the display screen, a plurality of input items assigned to the object; and
receiving one of the input items displayed in the displaying of a plurality of input items, according to the selection button operation.

11. An information processing system comprising:
a remote control that includes a plurality of selection buttons and outputs (i) a selection button operation corresponding to a press of one of the selection buttons and (ii) a cursor operation corresponding to a tilt of a case of the remote control; and
an information processing device that receives, from the remote control, the selection button operation and the cursor operation,
wherein the information processing device includes:
a display control unit configured to display a pointer on a display screen according to the cursor operation and display, if the pointer is on an object displayed on the display screen, a plurality of input items assigned to the objet; and
an input item receiving unit configured to receive one of the input items displayed by the display control unit, according to the selection button operation.
